(19) United States
(12) Patent Application Publication
(10) Pub. No.: US 2020/0005502 A1
(43) Pub. Date: Jan. 2, 2020

(54) AUTOMATED METHODS FOR CONSOLIDATING RAW SKETCHES INTO ARTIST-INTENDED CURVE DRAWINGS

(71) Applicant: The University of British Columbia, Vancouver (CA)

(72) Inventors: Alla SHEFFER, Vancouver (CA); Chenxi LIU, Vancouver (CA); Enrique ROSALES, Vancouver (CA)

(21) Appl. No.: 16/457,624

(22) Filed: Jun. 28, 2019

Related U.S. Application Data
(60) Provisional application No. 62/691,736, filed on Jun. 29, 2018.

(51) Int. Cl. G06T 11/20; G06T 11/60; G06K 9/46; G06K 9/34

(52) U.S. Cl. CPC G06T 11/203; G06K 9/342; G06K 9/4604; G06T 11/60

(57) ABSTRACT

A computer-implemented method converts a raw drawing into an artist-intended curve drawing. The method comprises: obtaining a raw drawing comprising a plurality of strokes; clustering the plurality of strokes into one or more clusters, each cluster comprising a corresponding group of strokes; for each more cluster, performing a curve fitting to determine a computer representation of a corresponding aggregate curve that is fitted to the group of strokes in the cluster; and generating a computer representation of an artist-intended curve drawing corresponding to the raw drawing. The curve drawing comprises the aggregate curve in place of the group of strokes corresponding to each cluster. Clustering the plurality of strokes into one more clusters comprises performing a plurality of iterative procedures to either group strokes into precursor clusters or to divide precursor clusters into precursor sub-clusters based on human perception models.

### REFERENCE TO RELATED APPLICATIONS

This application claims the benefit under 35 U.S.C. § 119 of application No. 62/691,736, filed 29 Jun. 2018, and entitled StrokeAggregator: Consolidating Raw Sketches into Artist-Intended Curve Drawings which is hereby incorporated herein by reference for all purposes.

### TECHNICAL FIELD

This disclosure relates to computer graphics and specifically to raw drawings or sketches as represented on a computer or similar processing environment. Particular embodiments provide automated methods for consolidating the strokes typically present in raw sketches into a number of artist-intended curves. Particular embodiments provide automated methods for converting computer representations of raw sketches into computer representations of artist-intended curves.

### BACKGROUND

Freehand line drawing provides a natural avenue for artists to quickly communicate shapes, ideas and images. When creating line drawings from scratch, artists often employ oversketching, using groups of multiple raw strokes to depict their intended, aggregate, curves. FIGS. 1A, 1C illustrate a number of examples 10, 20 of such raw sketches, each of which can be seen to comprise a number of groups of raw strokes 12, 22. Human observers can visually parse, or consolidate, these drawings 10, 20 by mentally replacing clusters of raw strokes 12, 22 with their corresponding aggregate curves. This is shown, for example, in corresponding drawings 110, 120 of FIGS. 1B, 1D, where a human observer has consolidated clusters of raw strokes 12, 22 into corresponding aggregate curves 112, 122. It may be desirable to generate the consolidated drawings 110, 120 of FIGS. 1B, 1D, by way of non-limiting example, to obtain more refined, colorized, or shaded drawings, or to use the consolidated drawings 110, 120 as input to editing or modeling software. To create the manually consolidated drawings 110, 120 of FIGS. 1B and 1D artists typically perform manual stroke consolidation by retracing the raw drawing 10, 20 and replacing raw stroke clusters 12, 22 with carefully drawn corresponding aggregate curves 112, 122. This manual stroke consolidation process can be time consuming and requires the input of a skilled artist.

There is a general desire to provide automated methods for consolidating the strokes 12, 22 typically present in raw sketches 10, 20 into a number of artist-intended curves 112, 122 to provide consolidated drawings 110, 120. There is a general desire to provide automated methods for converting computer representations of raw sketches 10, 20 and their pluralities of strokes 12, 22 into computer representations of artist-intended curves 112, 122 to provide computer representations of consolidated drawings 110, 120.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method for converting a raw drawing comprising a plurality of strokes into an artist-intended curve drawing. The method comprises: obtaining, at a computer system, a computer representation of a raw drawing, the raw drawing comprising a plurality of strokes, each stroke represented in a vector format in the computer system; clustering, by the computer system, the plurality of strokes into one or more clusters, each cluster comprising a corresponding group of one or more strokes; for each of the one or more clusters, performing a curve fitting, by the computer system, to thereby determine a computer representation of a corresponding aggregate curve that is fitted to the group of strokes in the cluster; and generating, by the computer system, a computer representation of an artist-intended curve drawing corresponding to the raw drawing, the artist-intended curve drawing comprising the aggregate curve corresponding to each cluster in place of the group of one or more strokes corresponding to each cluster. Clustering, by the computer system, the plurality of strokes into one more clusters comprises performing, by the computer system, a plurality of iterative procedures to either group strokes into precursor clusters or to divide precursor clusters into precursor sub-clusters based on one or more models of human perception of raw drawings comprising pluralities of strokes.

The plurality of iterative procedures to either group strokes into precursor clusters or to divide precursor clusters into precursor sub-clusters may comprise: generating, by the computer system, a precursor aggregate curve corresponding to a precursor cluster by performing, by the computer system, a curve fitting to fit the precursor aggregate curve to one or more strokes within the precursor cluster; for each of a plurality of discrete points on the precursor aggregate curve, determining, by the computer system, at least one parameter of the one or more models; and evaluating, by the computer system, whether the precursor cluster should be divided into precursor sub-clusters or combined with other strokes based on the at least one parameter determined at at least some of the plurality of discrete points on the precursor aggregate curve.

For each of the plurality of discrete points on the precursor aggregate curve, determining, by the computer system, the at least one parameter may comprise: determining, by the computer system, a first tangent t′ to the precursor aggregate curve at the point p′ on the precursor aggregate curve; determining, by the computer system, a second tangent t to a stroke in the precursor cluster at a point p on the stroke closest to the point p′ on the precursor aggregate curve; and determining, by the computer system, an angular distance between the first and second tangents (t, t′).

Evaluating, by the computer system, whether the precursor cluster should be divided into precursor sub-clusters or combined with other strokes based on the at least one parameter determined at at least some of the plurality of discrete points on the precursor aggregate curve may comprise determining, by the computer system, an aggregate angular distance between the stroke in the precursor cluster and the precursor aggregate curve based at least in part on a sum of the angular distances between the first and second tangents determined at the at least some of the plurality of discrete points on the precursor aggregate curve.

Evaluating, by the computer system, whether the precursor cluster should be divided into precursor sub-clusters or combined with other strokes based on the at least one parameter determined at at least some of the plurality of discrete points on the precursor aggregate curve may comprise determining, by the computer system, an aggregate angular distance between the stroke in the precursor cluster and a second stroke in the precursor cluster based on: the aggregate angular distance between the stroke in the precursor cluster and the precursor aggregate curve; and an aggregate angular distance between the second stroke in the precursor cluster and the precursor aggregate curve.

The plurality of iterative procedures to either group strokes into precursor clusters or to divide precursor clusters into precursor sub-clusters may comprise: determining, by the computer system, for each of a plurality of pairs of strokes (Sᵢ,Sⱼ) within the plurality of strokes of the raw drawing, an aggregate angular distance between the pair of strokes (Sᵢ,Sⱼ); assigning, by the computer system, an angular compatibility score ComA(Sᵢ,Sⱼ) to each of the plurality of pairs of strokes (Sᵢ,Sⱼ) based on the aggregate angular distance between the pair of strokes (Sᵢ,Sⱼ); and performing, by the computer system, an optimization which maximizes ΣᵢⱼComA(Sᵢ,Sⱼ)Yᵢⱼ, where Yᵢⱼ=1 if the pair of strokes (Sᵢ,Sⱼ) is grouped into a precursor cluster and Yᵢⱼ=0 otherwise.

The plurality of iterative procedures to either group strokes into precursor clusters or to divide precursor clusters into precursor sub-clusters may comprise: determining, by the computer system, for each of a plurality of pairs of strokes (Sᵢ,Sⱼ) within the plurality of strokes of the raw drawing, an aggregate angular distance between the pair of strokes (Sᵢ,Sⱼ); assigning, by the computer system, an angular compatibility score ComA(Sᵢ,Sⱼ) to each of the plurality of pairs of strokes (Sᵢ,Sⱼ) based on the aggregate angular distance between the pair of strokes (Sᵢ,Sⱼ); and performing, by the computer system, an optimization, which maximizes ΣᵢⱼComA(Sᵢ,Sⱼ)Yᵢⱼ, where Yᵢⱼ=1 if the pair of strokes (Sᵢ,Sⱼ) is grouped into a precursor cluster and Yᵢⱼ=0 otherwise, to groups strokes into precursor clusters.

For each of the plurality of discrete points on the precursor aggregate curve, determining, by the computer system, the at least one parameter may comprise: projecting, by the computer system, a first ray to from the point p′ on the precursor aggregate curve and extending to a left of the precursor aggregate curve in a first orientation orthogonal to the precursor aggregate curve at the point p′; projecting, by the computer system, a second ray from the point p′ on the precursor aggregate curve and extending to a right of the precursor aggregate curve in an second orientation orthogonal to the precursor aggregate curve at the point p′; determining, by the computer system, the at least one parameter based on a first intersection of the first ray with a first stroke Sᵢ from among the plurality of strokes of the raw drawing and a second intersection of the second ray with a second stroke Sⱼ from among the plurality of strokes of the raw drawing.

For each of the plurality of discrete points on the precursor aggregate curve, determining, by the computer system, the at least one parameter may comprise determining an inter-stroke distance between a point p at the first intersection of the first ray with the first stroke Sᵢ and a point q at the second intersection of the second ray with the second stroke Sⱼ according to ∥p−q∥.

Evaluating, by the computer system, whether a precursor cluster should be divided into precursor sub-clusters or combined with other strokes based on the at least one parameter determined at at least some of the plurality of discrete points on the precursor aggregate curve may comprise determining a stroke separation parameter D_{i,j}(I₁) between the first stroke Sᵢ and the second stroke Sⱼ based, at least in part, on a sum, over the discrete points on the precursor aggregate curve in a section I₁ of the precursor aggregate curve where the first stroke Sᵢ and the second stroke Sⱼ are side-by-side, of the inter-stroke distances ∥p−q∥ between the point p at the first intersection and the point q at the second intersection.

Evaluating, by the computer system, whether the precursor cluster should be divided into precursor sub-clusters or combined with other strokes based on the at least one parameter determined at at least some of the plurality of discrete points on the precursor aggregate curve may comprise: for each precursor cluster C, determining, by the computer system, an internal precursor cluster proximity parameter D_{c} based on the stroke separation parameters of the nearest neighbor strokes within the precursor cluster; for each pair of precursor clusters C, C′ determining, by the computer system, an intercluster spacing D_{c,c′} parameter based on the smallest stroke separation parameter between any two strokes where one of the two strokes belongs to the first precursor cluster C and the second one of the two strokes belongs to the second precursor cluster C′; and determining, by the computer system, that the pair of precursor clusters C, C′ should be merged into a single cluster based on evaluation of one or more merge criteria, the merge criteria based on the internal precursor cluster proximity parameters D_{c}, D_{c′} for each of the precursor clusters C, C′ and the intercluster spacing parameter D_{c,c′}.

Determining, by the computer system, that the pair of precursor clusters C, C′ should be merged into a single cluster based on evaluation of one or more merge criteria may comprise: merging, by the computer system, the pair of precursor clusters C, C′ if both of:

D_{c,c′}<T′_{d}·max(D_{c},D_{c′})

max(D_{c},D_{c′})<T′_{d}·min(D_{c},D_{c′})

are true, where T′_{d} is a constant; and maintaining the pair of precursor clusters C, C′ separate otherwise.

Evaluating, by the computer system, whether a precursor cluster should be divided into precursor sub-clusters or combined with other strokes based on the at least one parameter determined at at least some of the plurality of discrete points on the precursor aggregate curve may comprise: for each precursor cluster C, determining, by the computer system, an internal precursor cluster proximity parameter D_{c} based on the stroke separation parameters of the nearest neighbor strokes within the precursor cluster; for each pair of precursor clusters C, C′ determining, by the computer system, an intercluster spacing parameter D_{c,c′} based on a smallest stroke separation parameter between any two strokes where one of the two strokes belongs to the first precursor cluster C and the second one of the two strokes belongs to the second precursor cluster C′; and determining, by the computer system, that the pair of precursor clusters C, C′ should be merged into a single cluster based on evaluation of one or more merge criteria, the merge criteria based on the internal precursor cluster proximity parameters D_{c}, D_{c′} for each of the precursor clusters C, C′ and the intercluster spacing parameter D_{c,c′}.

The method may comprise: determining, by the computer system, that the first stroke Sᵢ and the second stroke Sⱼ are candidates for merger into a precursor cluster if, for any of the plurality of discrete points p′ on the precursor aggregate curve, the inter-stroke distance between a point p at the first intersection of the first ray with the first stroke Sᵢ and a point q at the second intersection of the second ray with the second stroke Sⱼ is less than a width threshold, the width threshold based on a width Wₛ of at least one of the first and second strokes; and otherwise, determining by the computer system, that the first stroke Sᵢ and the second stroke Sⱼ are not candidates for merger into the precursor cluster.

For each first stroke Sᵢ and second stroke Sⱼ determined to be candidates for merger into the precursor cluster, the method may comprise: determining, by the computer system, that the first stroke Sᵢ and the second stroke Sⱼ remain candidates for merger into the precursor cluster based, at least in part, on a sum, over the plurality of discrete points p′ on the precursor aggregate curve, of the angular distances between the tangents t at the point p at the first intersection of the first ray with the first stroke Sᵢ and at the point q at the second intersection of the second ray with the second stroke Sⱼ being less than a angular compatibility threshold, where p′=Mᵢ(p)=Mⱼ(q) and Mᵢ and Mⱼ are the mappings from the first and second strokes Sᵢ, Sⱼ to the precursor aggregate curve; and otherwise, determining by the computer system, that the first stroke Sᵢ and the second stroke Sⱼ are not candidates for merger into the precursor cluster.

The method may comprise for each first stroke Sᵢ and second stroke Sⱼ determined to remain candidates for merger into the precursor cluster: determining, by the computer system, that the first stroke Sᵢ and the second stroke Sⱼ should be merged into the precursor cluster based, at least in part, on determining, by the computer system, that a length to width ratio of the precursor aggregate curve in a section where the first stroke Sᵢ and the second stroke Sⱼ are side by side is greater than a narrowness threshold and, if it is determined that the first stroke Sᵢ and the second stroke Sⱼ should be merged into the precursor cluster, merging the first stroke Sᵢ and the second stroke Sⱼ into the precursor cluster; and otherwise, determining by the computer system, that the first stroke Sᵢ and the second stroke Sⱼ are not candidates for merger into the precursor cluster.

Determining, by the computer system, that a length to width ratio of the precursor aggregate curve in a section where the first stroke Sᵢ and the second stroke Sⱼ are side by side is greater than a narrowness threshold comprises traversing the discrete points p′ on the precursor aggregate curve and determining the farthest left and right intersections iₗ(p) and iᵣ(p) with first and second strokes Sᵢ, Sⱼ and determining width W_{c,ij} of the precursor aggregate curve according to W_{c,ij}=max(Wₛ,median_{p∈I}_{₁}(∥iₗ(p)−iᵣ(p)∥)), where I₁ is the set of discrete points on the precursor aggregate curve where the first stroke Sᵢ and the second stroke Sⱼ are side-by-side.

Performing, by the computer system, the plurality of iterative procedures to either group strokes into precursor clusters or to divide precursor clusters into precursor sub-clusters may comprise dividing precursor clusters into precursor sub-clusters. Dividing precursor clusters into precursor sub-clusters may comprise evaluating whether a precursor cluster should be divided into precursor sub-clusters and evaluating whether a precursor cluster should be divided into precursor sub-clusters may comprise: assessing, by the computer system, one or more separability criteria for the precursor cluster; and if the one or more separability criteria are satisfied: assigning, by the computer system, strokes from the precursor cluster to one of a pair of potential sub-clusters C_{L}, C_{R}; otherwise determining, by the computer system, that the precursor cluster is not separable.

Assessing the one or more separability criteria for the precursor cluster may comprise: generating, by the computer system, a precursor aggregate curve corresponding to the precursor cluster by performing, by the computer system, a curve fitting to fit the precursor aggregate curve to the strokes from the precursor cluster; for each of a plurality of discrete points on the precursor aggregate curve: projecting, by the computer system, a first ray to from the point p′ on the precursor aggregate curve and extending to a left of the precursor aggregate curve in a first orientation orthogonal to the precursor aggregate curve at the point p′; projecting, by the computer system, a second ray from the point p′ on the precursor aggregate curve and extending to a right of the precursor aggregate curve in an second orientation orthogonal to the precursor aggregate curve at the point p′; and determining, by the computer system, intersections between the first and second rays and the strokes in the precursor cluster and determining, for each pair of adjacent intersections, a gap corresponding to the distance between the adjacent intersections. The one or more separability criteria at each point p′ may be based at least in part on one or more of the gaps on the first and second rays projecting from the point p′.

Assigning, by the computer system, strokes from the precursor cluster to one of a pair of potential sub-clusters C_{L}, C_{R} may comprise, for a point on the aggregate curve where the one or more separability criteria are satisfied: assigning, by the computer system, strokes in the cluster intersected by the first ray to the potential sub-clusters C_{L} and assigning strokes in the cluster intersected by the second ray to the potential sub-clusters C_{R}; and considering, by the computer system, adjacent points on the aggregate curve and, at such adjacent points, assigning previously unassigned strokes to one of the potential sub-clusters C_{L}, C_{R} by an assignment that maximizes an average gap between the potential sub-clusters C_{L}, C_{R}.

Assessing, by the computer system, the one or more separability criteria for the precursor cluster may comprise: determining, by the computer system, that the pair of potential sub-clusters C_{L}, C_{R} is separable based at least in part on a gap ratio r determined for at least some of the points p′ on the precursor aggregate curve, the gap ratio r determined according to:

$$r = \frac{g}{( \frac{( {g}_{L} + {g}_{R} )}{2} )}$$

where g is a gap between a rightmost intersection with the first ray and the leftmost intersection with the second ray, g_{L} is an average of the gaps between the intersections between the strokes from the precursor cluster and the first ray and g_{R} is an average of the gaps between the intersections between the strokes from the precursor cluster and the second ray.

Determining, by the computer system, that the pair of potential sub-clusters C_{L}, C_{R} is separable based at least in part on a gap ratio r determined for at least some of the points p′ on the precursor aggregate curve may comprise: determining an aggregate gap ratio R based on the gap ratios r for a subset of the points p′ on the precursor aggregate curve; if the aggregate gap ratio R is greater than a gap-ratio threshold, then determining, by the computer system, that the pair of potential sub-clusters C_{L}, C_{R} is separable and separating the potential sub-clusters C_{L}, C_{R} into new precursor clusters; otherwise determining, by the computer system, that the pair of potential sub-clusters C_{L}, C_{R} should remain in the same precursor cluster.

Assessing, by the computer system, the one or more separability criteria for the precursor cluster may comprise: comparing a narrowness of the precursor cluster to a narrowness threshold, the narrowness comprising a ratio of a length of the precursor cluster to a maximal gap of the precursor cluster; if the narrowness of the precursor cluster is less than the narrowness threshold, determining, by the computer system, that the pair of potential sub-clusters C_{L}, C_{R} is separable and separating the potential sub-clusters C_{L}, C_{R} into new precursor clusters; otherwise determining, by the computer system, that the pair of potential sub-clusters C_{L}, C_{R} should remain in the same precursor cluster.

Performing, by the computer system, the plurality of iterative procedures to either group strokes into precursor clusters or to divide precursor clusters into precursor sub-clusters may comprise: assessing one or more unification criteria for a pair of precursor clusters; if the one or more unification criteria are satisfied grouping the pair of precursor clusters into a single precursor cluster; and otherwise determining that the pair of precursor clusters should remain as separate precursor clusters.

Assessing one or more unification criteria for the pair of precursor clusters may comprise at least one of: assessing, by the computer system, narrowness criteria between the pair of precursor clusters, the narrowness criteria based on a length to width ratio of a combined precursor aggregate curve fit to strokes within the pair of precursor clusters; assessing, by the computer system, an angular compatibility criteria: between a first precursor aggregate curve fit to strokes within a first one of the pair of precursor clusters and the combined precursor aggregate curve; and between the combined precursor aggregate curve and a second precursor aggregate curve fit to strokes within a second one of the pair of precursor clusters; and assessing, by the computer system, a proximity criteria which comprises: defining a first envelope comprising a region that includes all of the strokes in the first one of the pair of precursor clusters; defining a second envelope comprising a region that includes all of the strokes in the second one of the pair of precursor clusters; and determining a distance between the first and second envelopes.

Another aspect of the invention provides a computer system comprising one or more processors, the processors configured to: obtain a computer representation of a raw drawing, the raw drawing comprising a plurality of strokes, each stroke represented in a vector format in the computer system; cluster the plurality of strokes into one or more clusters, each cluster comprising a corresponding group of one or more strokes; for each of the one or more clusters, perform a curve fitting to thereby determine a computer representation of a corresponding aggregate curve that is fitted to the group of strokes in the cluster; and generate a computer representation of an artist-intended curve drawing corresponding to the raw drawing, the artist-intended curve drawing comprising the aggregate curve corresponding to each cluster in place of the group of one or more strokes corresponding to each cluster; wherein the one or more processors are configured to cluster the plurality of strokes into one more clusters by performing a plurality of iterative procedures to either group strokes into precursor clusters or to divide precursor clusters into precursor sub-clusters based on one or more models of human perception of raw drawings comprising pluralities of strokes.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is an example of a raw sketch comprising a plurality of raw strokes of the type that may be input to the methods of particular embodiments of the invention. FIG. 1B is an example of a drawing corresponding to the raw sketch of FIG. 1A, where a human observer has consolidated clusters of raw strokes into corresponding aggregate curves. FIG. 1C is another example of a raw sketch comprising a plurality of raw strokes of the type that may be input to the methods of particular embodiments of the invention. FIG. 1D is an example of a drawing corresponding to the raw sketch of FIG. 1C, where a human observer has consolidated clusters of raw strokes into corresponding aggregate curves.

FIG. 2 is a schematic block diagram of an automated method for consolidating a raw sketch into artist-intended curve drawing according to an example embodiment.

FIGS. 3A-3D are example illustrations intended to demonstrate how humans perceive different criteria as bases for making clustering decisions.

FIG. 4 is a schematic depiction of a method for automatedly implementing the coarse-to-fine clustering of the FIG. 2 method in accordance with some embodiments.

FIG. 5A schematically illustrates a method for implementing the angular compatibility-based clustering of the FIG. 4 method according to a particular embodiment. FIG. 5B is a schematic illustration of a section of interest on an aggregate curve SA between a pair of strokes (Sᵢ,Sⱼ).

FIG. 6A schematically illustrates a method for implementing the proximity based clustering refinement of the FIG. 4 method according to a particular embodiment. FIG. 6B schematically illustrates a method for implementing the sub-cluster initialization procedure of the FIG. 6A method according to a particular embodiment. FIG. 6C is a schematic illustration of the method for determining the average distance D_{i,j}(I₁) between a pair of strokes Sᵢ, Sⱼ according to particular embodiment.

FIG. 7A schematically illustrates a method for implementing the cluster width and spacing uniformity assessment of the FIG. 4 method according to a particular embodiment. FIG. 7B schematically illustrates a method for implementing the step of determining potentially separable clusters of the FIG. 7A method according to a particular embodiment. FIG. 7C schematically illustrates the evaluation of potentially separable clusters. FIG. 7D schematically illustrates a portion of the FIG. 7C evaluation where the ratio parameter r>0. FIG. 7E schematically illustrates a portion of the FIG. 7C evaluation where the ration parameter r is set equal to r=0. FIGS. 7F and 7G show an exemplary scenario for dividing a potentially separable cluster into a pair of sub-clusters C_{L}, C_{R}.

FIG. 8A schematically depicts a method that may be used to perform the ambiguity resolution procedures the FIG. 4 method according to a particular embodiment. FIG. 8B schematically depicts an example of a cluster envelope of the type used in the method of FIG. 8A.

FIG. 9 schematically depicts one example of a computer system which may be used to practice aspects of the current invention according to a particular embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Aspects of the invention provide automated methods for consolidating the strokes typically present in raw sketches into a number of artist-intended curves. Particular aspects provide automated methods for converting computer representations of raw sketches into computer representations of artist-intended curves. In some embodiments, the strokes present in the input raw sketch are clustered according to an automated method which attempts to mimic the mental processes that human viewers apply to consolidate the strokes in a raw sketch. Then, once clustered, consolidated curves are generated for each cluster to arrive at the corresponding output drawing with artist-intended curves.

Aspects of the invention provide a method for converting a raw drawing comprising a plurality of overdrawn strokes into an artist-intended curve drawing. The method comprises: obtaining, at a computer system, a computer representation of a raw drawing, the raw drawing comprising a plurality of strokes, each stroke represented in a vector format in the computer system; clustering, by the computer system, the plurality of strokes into one or more clusters, each cluster comprising a corresponding group of one or more strokes; for each of the one or more clusters, performing a curve fitting, by the computer system, to thereby determine a computer representation of a corresponding aggregate curve that is fitted to the group of strokes in the cluster; and generating, by the computer system, a computer representation of an artist-intended curve drawing corresponding to the raw drawing, the artist-intended curve drawing comprising the aggregate curve corresponding to each cluster in place of the group of one or more strokes corresponding to each cluster. Clustering the plurality of strokes into one more clusters comprises performing, by the computer system, a plurality of iterative procedures to either group strokes into precursor clusters or to divide precursor clusters into precursor sub-clusters based on one or more models of human perception of raw drawings comprising overdrawn strokes.

### General Overview

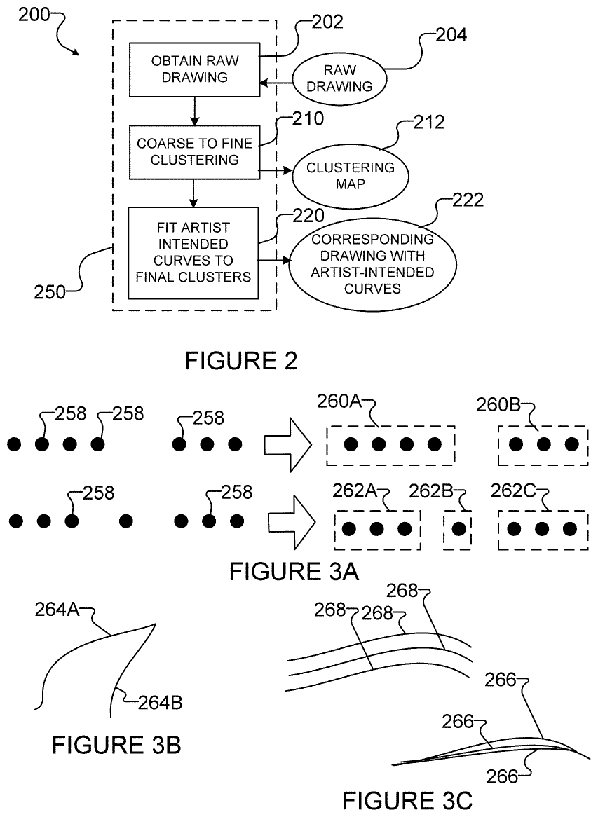

FIG. 2 is a schematic block diagram of an automated method 200 for consolidating a raw sketch 204 into an artist-intended curve drawing 222 according to an example embodiment. Automated drawing conversion method 200 may be implemented, at least in part, by one or more computers or suitably configured processors 250—shown in dashed lines in FIG. 2.

Method 200 starts in block 202, which comprises procuring a raw drawing 204 as input. In some embodiments, raw drawing 204 is received as input to computer system 250. In some embodiments, raw drawing 204 may be obtained in block 202 in a computer graphic representation known as a vector formatted graphic representation. In some embodiments, raw drawing 204 may be converted (e.g. in block 202 or otherwise) from another format (e.g. a raster format) into a vector formatted representation. In some embodiments, raw drawing 204 may be generated on paper and scanned or generated on some other computer and/or the like and may be provided to computer system 250 as input. In some such embodiments, raw drawing 204 may be converted from a raster format into a vector format. In some embodiments, raw drawing 204 may be generated in computer system 250 and may be generated using the same software as that which implements drawing conversion method 200 or using different software (e.g. commercial drawing and/or sketching software (Adobe Illustrator, Autodesk Sketchbook, Inkscape and/or the like) and/or the like).

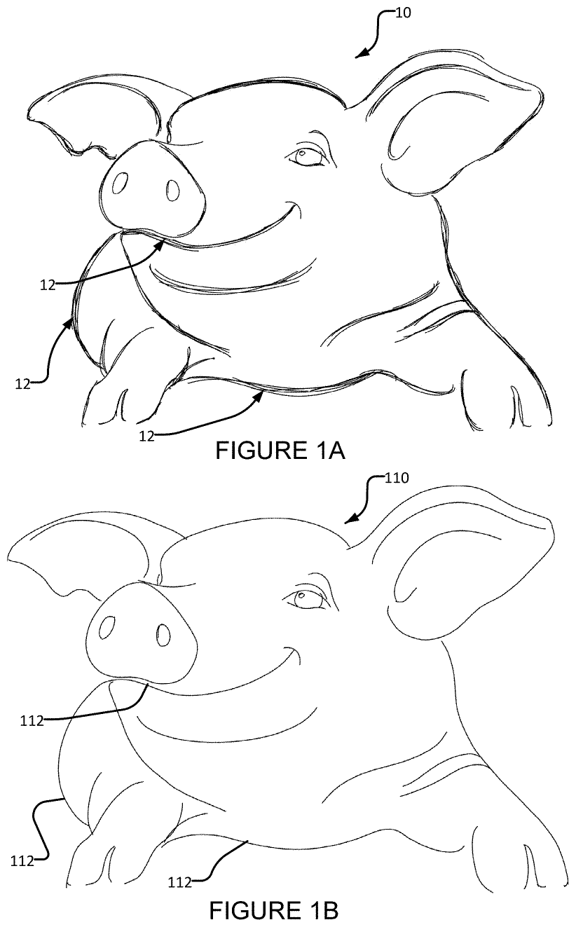

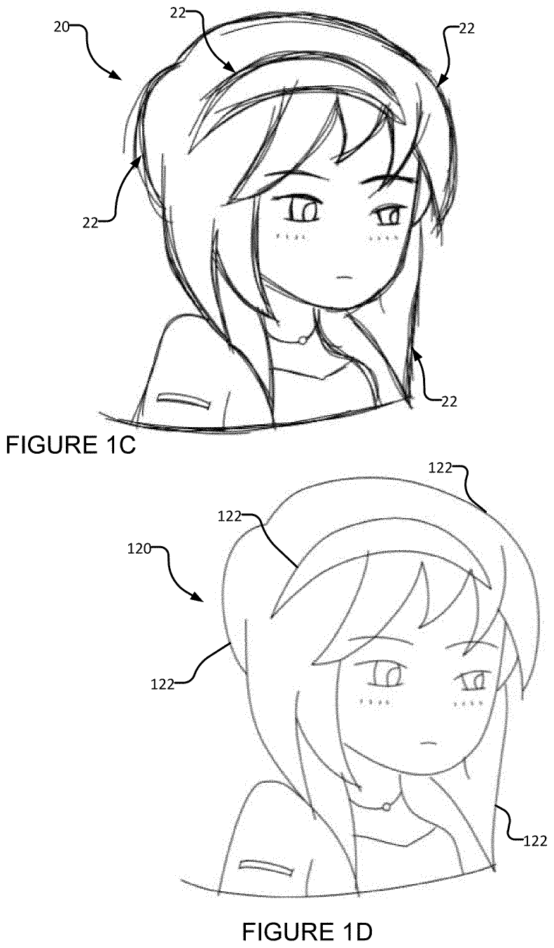

Exemplary and non-limiting raw drawings 204 are illustrated as drawings 10, 20 in FIGS. 1A, 1C. The object underlying raw drawing 10 (FIG. 1A) is a pig and the object underlying raw drawing 20 (FIG. 1C) is a cartoon person. It will be appreciated that raw drawings 10, 20 of FIGS. 1A, 1C are only representative examples of the types of raw drawings 204 that could be used by method 200. In general, method 200 may be used to with any suitable raw drawings 204 comprising a plurality of drawing strokes (e.g. drawing strokes 12, 22 of example drawings 10, 20).

In some embodiments, raw drawing 204 may be created by an artist using a tablet or other stylus-sensitive display which, together with suitable drawing software (not shown), can be used to create line drawings 204 within the software and have the strokes of the raw drawing 204 recorded in vector format. For example, raw drawing 204 may be obtained (in block 202) using a standard stylus interface (e.g. pen tablets such as the Wacom, Intuos™ series and Bamboo™ series and/or the like or pen displays such as the Wacom, Cintiq™ series and/or the like), where each stroke is represented by a polyline. In some such embodiments, each stroke of raw drawing 204 (see strokes 12, 22 of raw drawings 10, 20 of FIGS. 1A, 1C) may have or may be assigned an associated width value. In some embodiments, such a width value may be generated, for example, via pressure of the stylus on the stylus-sensitive display or via some other user-interface specification. In some embodiments, if such width values are not available, all strokes may be assigned a common width value (e.g. a width value of unity).

Raw strokes captured via a stylus interface are often noisy due to a combination of involuntary hand movement and capture software inaccuracy. In some embodiments, data obtained direction from a stylus interface may optionally be pre-processed to remove such noise-related artefacts by smoothing and densely resampling individual strokes. Such optional pre-processing may be performed as part of obtaining raw drawing 204 in block 202 or prior to obtaining raw drawing 204 in block 202.

In some such embodiments, such smoothing and dense resampling may be performed using the Cornucopia method suggested by Baran, et al. 2010. Sketching clothoid splines using shortest paths. In Computer Graphics Forum, Vol. 29. 655-664, which is hereby incorporated herein by reference. To preserve the input stroke shape as much as possible, in some embodiments, the Cornucopia “error cost” may be set to 5, which keeps the output stroke close to the input. In some embodiments, the original strokes are cut at Cornucopia-detected C⁰ discontinuities, as well as at sharp curvature extrema, where the curvature is both high (e.g. larger than 0.125 in some embodiments) and distinct from that along the rest of the curve (e.g. at least three times the median curvature in some embodiments).

The hanging portion of so-called hooks which are commonly present at the end of strokes represent capture artifacts and not part of the intended artist input, and, consequently, may be deleted during optional pre-processing. The hanging portions of hooks may be classified as segments between a detected discontinuity and an end point if the segment is both short in absolute terms (e.g. less than 15Wₛ in some embodiments, where Wₛ represents a width of the stroke) and forms less than a threshold percentage (e.g. less than 15% in some embodiments) of the overall stroke length.

Method 200 then proceeds to block 210 which involves generating a clustering map 212. The block 210 clustering map 212 assigns the strokes of raw drawing 204 to corresponding clusters. For example, each stroke of raw drawing 204 may be assigned to a particular cluster in clustering map 212. The block 210 clustering process may be based on mimicking the mental processes that human viewers apply to consolidate the strokes in a raw sketch. As explained in more detail below, the block 210 clustering process may be implemented as a coarse-to-fine gradual clustering algorithm which may comprise: forming initial coarse clusters based on angular compatibility between strokes; refining the initial coarse clusters based on average pairwise distance between them, to form clusters of roughly evenly spaced strokes; assessing intra-cluster stroke spacing to detect and separate stroke branches; and analyzing the internal consistency of the computed clusters to resolve ambiguities and to merge clusters which are both angle and spacing compatible.

Once clustering map 212 is obtain in block 210, method 200 proceeds to block 220 which comprises fitting shape-preserving artist-intended curves to the individual clusters in clustering map 212 to arrive at output drawing 222 which corresponds with raw drawing 204 but which comprises artist-intended curves in the place of raw strokes. Specifically, output drawing 222 comprises artist-intended aggregate curves. These aggregate curves in output drawing 22 replace clusters of strokes that jointly depict individual artist intended curves (within raw drawing 204). In some embodiments, the aggregate curves in output drawing 222 may be represented in vector format as polylines with an optional associated width.

The clustering techniques used in block 210 of method 200 in accordance with particular embodiments of the invention are now described in more detail. The disclosure starts with a discussion of how humans perceive oversketched strokes in raw drawings (e.g. strokes 12, 22 in drawings 10, 20 of FIGS. 1A, 1C). The disclosure then describes a suitable algorithm for implementing a coarse-to-fine clustering in block 210 in accordance with some embodiments.

### Human Perception of Oversketched Strokes

Humans are capable of perceiving aggregated curved lines (e.g. curves 112, 122 of drawings 110, 120 of FIGS. 1B, 1D) from raw sketches which include oversketched strokes (e.g. strokes 12, 22 of sketches 10, 20 of FIGS. 1A, 1C).

Angular Compatibility. Studies indicate that viewers rely on angular compatibility between strokes when grouping nearby strokes. Angular compatibility between strokes may be represented by the degree of similarity between stroke tangents. Strokes with similarly oriented tangents over the length of the stroke may be interpreted by humans to belong together (i.e. because they represent the same aggregate line).

Relative Proximity.

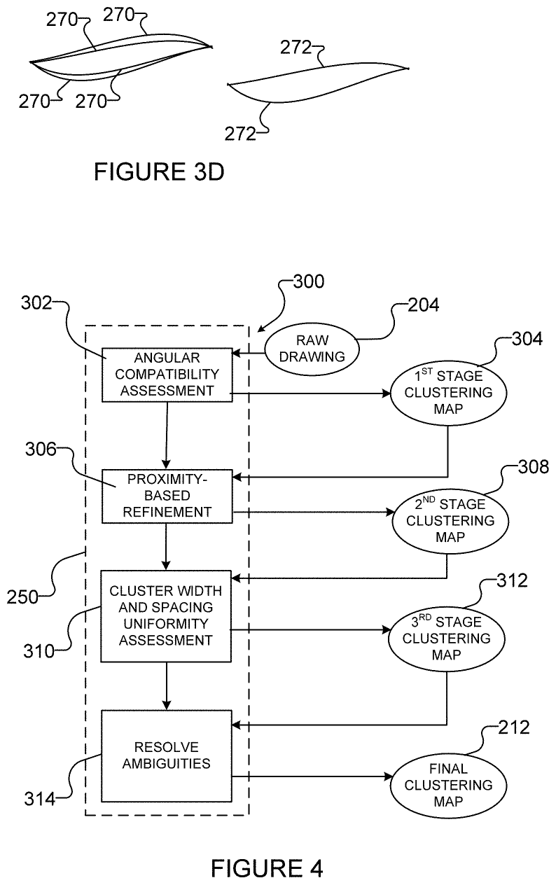

Perceptual literature strongly suggests that humans group objects based on relative proximity, or relative distance. Given a set of shapes, humans tend to visually group objects if the spacing between them is much smaller than the space between them and other objects. An example of this grouping based on relative proximity is shown in FIG. 3A, where the upper set of objects 258 would typically be divided into two groups 260A, 260B, whereas the lower set of objects 258 would typically be grouped into three groups 262A, 262B, 262C. Proximity can also be interpreted as a function of density: strokes within a perceived group may have a near-constant internal object density, while incorporating any other stroke into the group would result in highly uneven density.

It may be observed that proximity based grouping is contextual—for example, similarly spaced objects 258 (FIG. 3A) are seen as belonging to the same, or different, groups based on the position of other objects 258. Also note that proximity based grouping tends to be scale independent, scaling all distances in FIG. 3A by the same amount will not change the grouping.

Using proximity as a criterion for stroke grouping poses several challenges. First, it requires context, since one cannot assess the relative proximity of any individual pair of strokes. Second, relative proximity tends to be a negative rather than positive property. That is, relative proximity indicates when objects do not belong together—when both or one of them have much more proximate objects—not when objects do belong together. For roughly evenly spaced strokes, relative proximity alone does not tend to provide a cue as to whether these strokes should, or should not, belong together. Lastly, distances between side-by-side strokes tend to vary at different points along them, raising a question of how to assess proximity locally.

Narrowness.

Humans tend to intuitively understand curves as being narrow, namely having a small width to length ratio. This intuition may help to distinguish between equally spaces strokes that jointly depict aggregate curves and those that do not. FIG. 3B shows an example of this, where strokes 264A, 264B may be perceived to be separate, even when they are angularly compatible and proximate. In some embodiments, a narrowness (width to length ratio) of a stroke may be incorporated in the block 210 clustering algorithm.

Connectedness.

The connectedness principle highlighted by perception research suggests that humans group objects (e.g. strokes) that are inter-connected, such as points connected by lines. For strokes, this principle argues for grouping intersecting or near intersecting strokes when doing so does not contradict other cues. This is illustrated, for example, in FIG. 3C, where strokes 266 may be perceived to be connected and to belong to the same group, whereas strokes 268 may be perceived to belong to different groups because of their lack of connection.

Strength in Numbers.

Even with the aforementioned cues in place, there remain stroke configurations which, from a human-perception driven perspective, are ambiguous.

This is illustrated, for example, in FIG. 3D, where it would seem intuitive to group strokes 270 into two groups, but it is not as evident whether strokes 272 should be grouped into one group or two groups. In some embodiments, these types of configurations may be addressed by leveraging artist intent. Specifically, raw drawing inputs 204 (FIG. 2) are typically generated by artists who intend for viewers to assemble a clear mental image of the drawn content. Research suggests that artists tend to rely on thicker, overdrawn, lines to enhance drawing clarity and eliminate ambiguities. This observation suggests that artists use tight multi-stroke clusters to highlight intended aggregate curves that may be ambiguous when drawn with a single stroke—see, for example, strokes 270 of FIG. 3D, when compared to the ambiguous strokes 272. This principle (use of multiple strokes in cases of ambiguity) may be referred to as strength in numbers and may be used, in some embodiments, to resolve ambiguous configurations, by using the number of strokes within a cluster as a factor in the block 210 clustering decision making.

### Automated Stroke Clustering

FIG. 4 is a schematic depiction of a method 300 for automatedly implementing the block 210 coarse-to-fine clustering (FIG. 2) in accordance with some embodiments.

Method 300 may be performed by computer system 250 (schematically depicted using dashed lines in FIG. 4). Method 300 comprises a plurality of iterative procedures to either group strokes into clusters or to divide clusters into sub-clusters. The output of the FIG. 4 method 300 is a clustering map 212, which may be used by method 200 (FIG. 2) to generate an output drawing 222 corresponding to raw drawing 204 but comprising artist-intended aggregate curves in the place of strokes—e.g. an artist intended aggregate curve for each cluster of strokes in clustering map 212. Referring to the illustrated embodiment of FIG. 4, the plurality of iterative procedures to either group strokes into clusters or to divide clusters into sub-clusters may generate first stage clustering map 304, second stage clustering map 308 and third stage clustering map 312 prior to generating final clustering map 212. Clusters and sub-clusters that form part of first stage clustering map 304, second stage clustering map 308, third stage clustering map 312 and/or otherwise created, used, processed or analyzed during method 300 prior to the generation of final clustering map 212 may be referred to as precursor clusters. However, for brevity, the “precursor” adjective may be dropped in this disclosure when the context is clear.

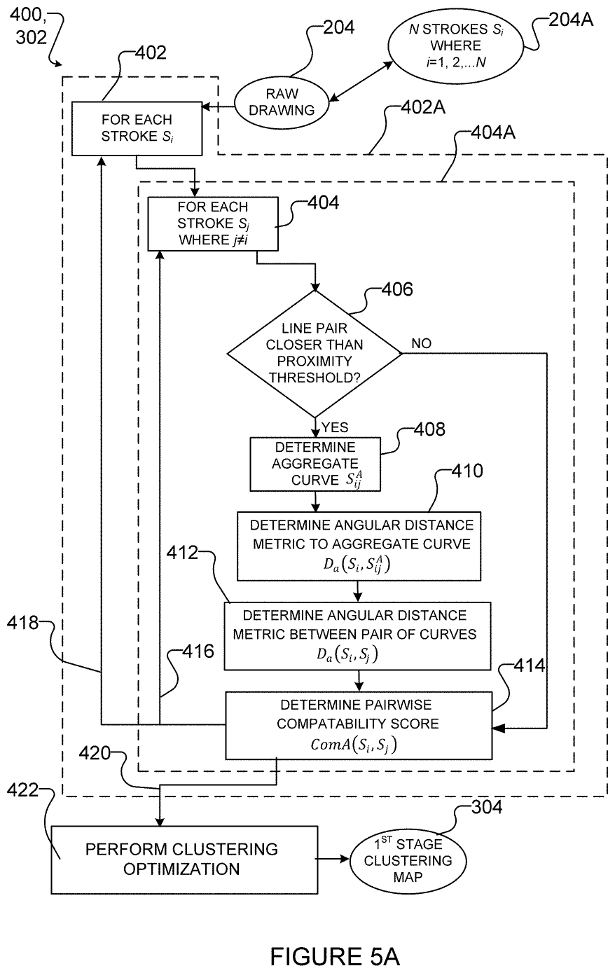

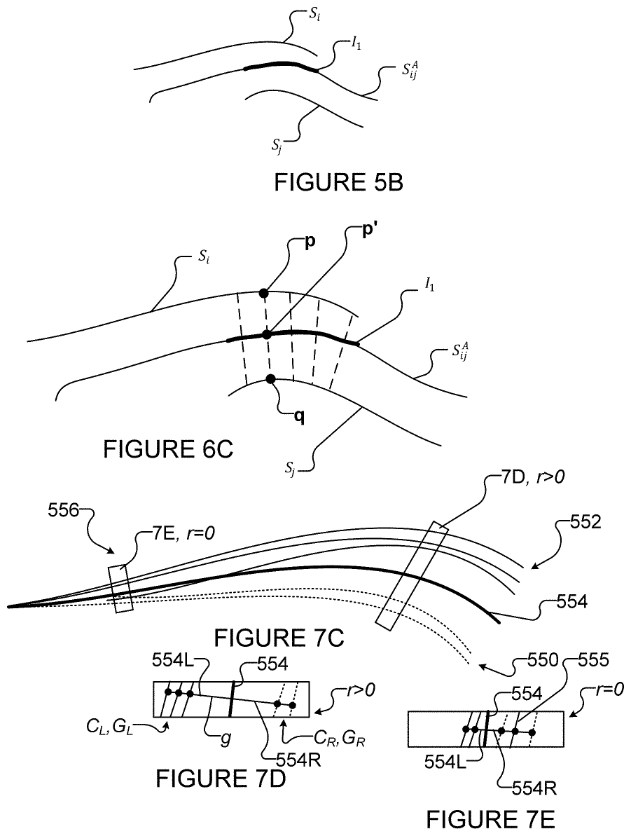

Method 300 begins in block 302 which comprises using the strokes that form part of raw input drawing 204 to implement a coarse clustering based on angular compatibility and to arrive at a first stage clustering map 304. FIG. 5A schematically illustrates a method 400 for implementing the block 302 angular compatibility-based clustering according to a particular embodiment. Method 400 may be performed by computer system 250 (FIG. 4), which is not expressly illustrated in FIG. 5A. For the purposes of explaining method 400, it is assumed (without loss of generality) that raw drawing 204 is represented as (or can be converted to) a set 204A of N strokes Sᵢ where i∈{1, 2, 3 . . . N}.

Method 400 comprises a first loop 402A which (in the schematic illustration of FIG. 5A) is controlled by block 402 and which is performed once for each stroke Sᵢ. Method 400 also comprises a second loop 404A which (in the schematic illustration of FIG. 5A) is controlled by block 404 and which is performed once for each pair of strokes (Sᵢ,Sⱼ) where j#i. The control for these loops is represented (in the schematic illustration of FIG. 5A) by the “for” statements of blocks 402, 404 respectively. Other than for explaining that first loop 402A is performed once for each stroke Sᵢ and that second loop 404A is performed once for each pair of strokes (Sᵢ,Sⱼ), the details of the control of these loops 402A, 404A is not expressly described herein or shown in FIG. 5A. However, it will be appreciated that once loop 404A is performed for stroke pair (Sᵢ,Sⱼ), loop 404A need not be performed again for stroke pair (Sⱼ,Sᵢ).

The angular compatibility between a stroke pair (Sᵢ,Sⱼ) provides a first cue about whether these strokes are meant to depict a common aggregate curve. Two nearby strokes Sᵢ and Sⱼ are more likely to depict the same aggregate curve when they are fully or partially parallel and are less likely to depict the same aggregate curve when they are orthogonal to one another. As described in more detail below, method 400 may involve determining an angular compatibility score ComA(Sᵢ,Sⱼ) between each stroke pair (Sᵢ,Sⱼ). This angular compatibility score ComA(Sᵢ,Sⱼ) may be set to be positive for stroke pairs that are angle compatible, and negative for those which are not. The value (e.g. magnitude) of the angular compatibility score ComA(Sᵢ,Sⱼ) may reflect the degree of (in)compatibility.

For a particular pair of strokes (Sᵢ,Sⱼ), block 406 comprises evaluating a proximity threshold inquiry. In general, the angular compatibility being assessed in block 302 (method 400) only impacts clustering decisions for nearby strokes. If the pair of strokes (Sᵢ,Sⱼ) are spaced far apart, it may be expected that such strokes will only end up in the same cluster if there are some other criteria (e.g. intermediate proximate and angularly compatible strokes) for grouping the spaced apart strokes. Accordingly, block 406 involves assessing whether the current pair of strokes (Sᵢ,Sⱼ) is within (closer to one another than) a proximity threshold.

The block 406 assessment may take place between the closest pair of points on the current stroke pair (Sᵢ,Sⱼ).

The block 406 proximity threshold may be a configurable (e.g. user-configurable) parameter of method 400. In some embodiments, the block 406 proximity threshold may be defined relative to the stroke width Wₛ of the i^{th} or j^{th} stroke. By way of non-limiting example, the block 406 proximity threshold may be defined to be AWₛ, where A is a multiplying factor (e.g. A=10, A=20, A=50 or the like). If the current pair of pair of strokes (Sᵢ,Sⱼ) is within the block 406 proximity threshold, then method 400 proceeds via block 406 YES branch to block 408. Otherwise, method 400 proceeds via block 406 NO branch directly to block 414.

Assuming, for the moment, that method 400 proceeds to block 408 for the current stroke pair (Sᵢ,Sⱼ), block 408 involves determining an aggregate curve Sᵢⱼ^{A} for the current pair of strokes (Sᵢ,Sⱼ). The block 408 aggregate curve Sᵢⱼ^{A} may comprise a curve fitted between the current pair of strokes (Sᵢ,Sⱼ). In general, the block 408 aggregate curve Sᵢⱼ^{A} may be determined by any suitable curve fitting technique. A particular embodiment for determining aggregate curves for a plurality of stokes (including the block 408 aggregate curve Sᵢⱼ^{A}) is described in more detail below.

Method 400 then proceeds to block 410, which involves determining an aggregate angular distance metric Dₐ(Sᵢ,Sᵢⱼ^{A}) between each of the current pair of strokes (Sᵢ,Sⱼ) and the aggregate curve Sᵢⱼ^{A}. The block 410 procedure for determining the aggregate angular distance metric Dₐ(Sᵢ,Sᵢⱼ^{A}) between each of the current pair of strokes (Sᵢ,Sⱼ) and the aggregate curve Sᵢⱼ^{A} may comprise the following steps. For a point p∈Sᵢ on the stroke Sᵢ, we may define the corresponding point p′∈Sᵢⱼ^{A} as its closest point on the aggregate curve Sᵢⱼ^{A}. Given this correspondence mapping p′=Mᵢ(p), we may compute the pointwise angular difference at p′ as Aᵢ(p′)=arccos(t·t′), where t and t′ are unit tangents to Sᵢ and Sᵢⱼ^{A} at points p and p′ respectively.

Because we intend to use the aggregate angular distance metric Dₐ(Sᵢ,Sᵢⱼ^{A}) to evaluate whether two strokes (Sᵢ,Sⱼ) are roughly parallel, in some embodiments, instead of integrating angular distances along the entire aggregate curve Sᵢⱼ^{A}, the block 410 determination may be narrowed to sections I₁ of interest (e.g. where points on the aggregate curve Sᵢⱼ^{A} have corresponding points on both of the current pair of strokes (Sᵢ,Sⱼ). Such a section I₁ is illustrated in FIG. 5B by the thickened section of the aggregate curve Sᵢⱼ^{A}. A section of interest I₁ may be ascertained by shooting orthogonal rays from densely sampled points p′ on the aggregate curve Sᵢⱼ^{A} and ensuring that these orthogonal rays intersect both strokes Sᵢ,Sⱼ. The use of such orthogonal rays is described in more detail below in connection with determining the interstroke distance D_{i,j} in block 454 (method 480) and in connection with equation (5). In some embodiments, the points p′ along aggregate curve Sᵢⱼ^{A} and define the aggregate angular distance metric Dₐ(Sᵢ,Sᵢⱼ^{A}) according to:

$${D}_{a} ( {S}_{i} , {S}_{ij}^{A} ) = \frac{1}{\vert {I}_{1} \vert} {\sum }_{{p}^{′} ∈ {I}_{1}} {A}_{i} ( {p}^{′} ) \qquad ( 1 )$$

where |₁| represents the number of samples along the section I₁.

Method 400 then proceeds to block 412 which may involve choosing one angular distance metric Dₐ(Sₜ, Sⱼ) to be the angular distance metric between the current pair of strokes (Sᵢ,Sⱼ). In some embodiments, the block 412 angular distance metric Dₐ(Sᵢ,Sⱼ) between the current pair of strokes (Sᵢ,Sⱼ) may be set according to

Dₐ(Sᵢ,Sⱼ)=max(Dₐ(Sᵢ,Sᵢⱼ^{A}),Dₐ(Sᵢ,Sᵢⱼ^{A})) (2)

Since each point p on each of the current pair of strokes (Sᵢ,Sⱼ) has a corresponding point p′ on the fitted curve Sᵢⱼ^{A}, the equation (1A) formulation addresses all possible stroke configurations, providing a unified measure.

Method 400 may then proceed to block 414 where the block 412 angular distance metric Dₐ(Sᵢ,Sⱼ) between the current pair of strokes (Sᵢ,Sⱼ) may be converted to an angular compatibility score ComA(Sᵢ,Sⱼ) between the current stroke pair (Sᵢ,Sⱼ). In some embodiments, this angular compatibility score ComA(Sᵢ,Sⱼ) may be determined according to:

$$ComA ( {S}_{i} , {S}_{j} ) = \{ \begin{matrix}1 , & φ < 8 ° \\ exp ( - \frac{{( φ - 8 ° )}^{2}}{2 {σ}_{1}^{2}} ) , & 8 ° \leq φ < 17 ° \\ 0 , & 17 ° \leq φ < 23 ° \\ - 1.5 exp ( - \frac{{( φ - 30 ° )}^{2}}{2 {σ}_{2}^{2}} ) , & 23 ° \leq φ < 30 ° \\ - 1.5 , & 30 ° \leq φ\end{matrix} \qquad ( 3 )$$

where, for brevity, we have used ϕ=Dₐ(Sᵢ,Sⱼ).

The parameters of the equation (3) function for angular compatibility score ComA(Sᵢ,Sⱼ) reflect cues from perception research, which indicate that viewers use approximately Tₐ=20° as a threshold distinguishing between perceived similar and dissimilar tangents. Equation (3) is therefore centered around this angular threshold value Tₐ. The parameters σ₁² and σ₂² represent the standard deviation parameters of a pair of Gaussian curves. The spread of these Gaussians (as determined by the parameters σ₁² and σ₂²) may be set to create smooth dropoff. By way of non-limiting example, in some embodiments, σ₁=2.57°=9°/3.5 and σ₂=2°=7°/3.5. In some embodiments, at this stage, block 414 involves a conservative assessment of clusters, and, consequently, equation (2) involves the use of a higher amplitude negative than positive maximal correlation score (1 v.s. −1.5).

It will be appreciated by those skilled in the art that any of the constants in equation (3) and the parameters σ₁² and σ₂² may be configurable (e.g. user configurable) to achieve different outcomes.

Method 400 may also arrive in block 414 via the NO branch of block 406. In such a circumstance, it has been determined that the current stroke pair (Sᵢ,Sⱼ) is unlikely to be clustered together merely by the angular compatibility in the absence of some other criteria (e.g. intermediate proximate and angularly compatible strokes). In such cases, the angular compatibility score ComA(Sᵢ,Sⱼ) between that pair of strokes may be set to a small amplitude negative number (e.g. −10⁻⁶). This small amplitude negative number may be selected to be small enough to allow strokes to be grouped together if they exhibit some other criteria indicative of clustering (e.g. they share angle compatible intermediate strokes), but to push the strokes apart (i.e. to be non-clustered) otherwise.

While not expressly shown in FIG. 5A, the compatibility score ComA(Sᵢ,Sⱼ) for a pair of strokes (Sᵢ,Sⱼ) may also be set to a small amplitude negative number in block 414 if the pair of strokes (Sᵢ,Sⱼ) has no side by side sections (see FIG. 5B and the discussion above).

Method 400 exits from block 414 along one of paths 416, 418, or 420, depending on the particular state of the loop indices for loops 402A, 404A. If it is desired to iterate loop 404A again for the same stroke Sᵢ, but for a different stroke Sⱼ (e.g. to increment the index j), then method 400 proceeds back to block 404 via path 416 (where the index j is incremented and another iteration of loop 404A is performed). If stroke Sᵢ has been completely evaluated and it is desired to increment the index i to evaluate a new stroke Sᵢ, then method 400 proceeds back to block 402 via path 418 (where the index i is incremented, the index j is reset and another iteration of loop 402A is performed). If the angular compatibility score ComA(Sᵢ,Sⱼ) has been evaluated for each stroke pair, then method 400 proceeds to block 422.

Block 422 involves performing a clustering optimization. It will be noted that block 422 is performed once (i.e. is not part of loop 402A or loop 404A). Given the angular compatibility scores ComA(Sᵢ,Sⱼ), the block 422 clustering optimization may be used to group stroke pairs with positive scores, to separate strokes with negative scores, and to resolve ambiguities by considering the magnitude of the scores. This set of requirements naturally fits into a correlation clustering framework. An advantage of using correlation clustering over other clustering formulations is that the number of clusters emerges directly from the input scores and does not need to be estimated a priori. In some embodiments, the block 422 clustering optimization may be formulated according to maximizing the objective function:

ΣᵢⱼComA(Sᵢ,Sⱼ)Yᵢⱼ (4)

where Yᵢⱼ∈{0,1}, Yᵢⱼ=1 if the i^{th} and j^{th} strokes are determined to be in the same cluster and Yᵢⱼ=0 otherwise. Obtaining an optimal correlation clustering in block 422 is a NP-complete problem, which is computationally expensive. Consequently, in some embodiments, any one of a variety of methods (e.g. the method of Keuper et al. in Keuper et al. 2015. Efficient decomposition of image and mesh graphs by lifted multicuts. In Proc. ICCV. 1751-1759, which is hereby incorporated herein by reference) may be used to efficiently provide an approximate solution to the equation (4) optimization problem.

The output of block 414 (and method 400 and block 302) is a first stage clustering map 304. First stage clustering map 304 may assign a cluster label to each of strokes Sᵢ where i∈{1, 2, 3 . . . N} in the raw drawing 204. Strokes which share a common cluster label in first stage clustering map 304 may be said to belong to or be in the same cluster in first stage clustering map 304. Conversely, strokes with different cluster labels in first stage clustering map 304 may be said to belong to or be in different clusters in first stage clustering map 304.

Returning now to method 300 (FIG. 4), first stage clustering map 304 is used as input to the block 306 procedure which involves proximity based refinement of first stage clustering map 304 to obtain second stage clustering map 308. First stage clustering map 304 generated in block 302 focuses on angular compatibility, and, consequently, may assign strokes to be in a single cluster even if such strokes are visibly disjoint. Block 306 may separate such strokes by breaking angle compatible clusters (from among first stage clustering map 304) into sub-clusters with no sudden internal proximity changes based on average inter-stroke proximity. Block 306 results in second stage clustering map 308, which parses first stage clustering map 304 into clusters which may be narrow enough to be effectively parameterized via a shared aggregate curve.

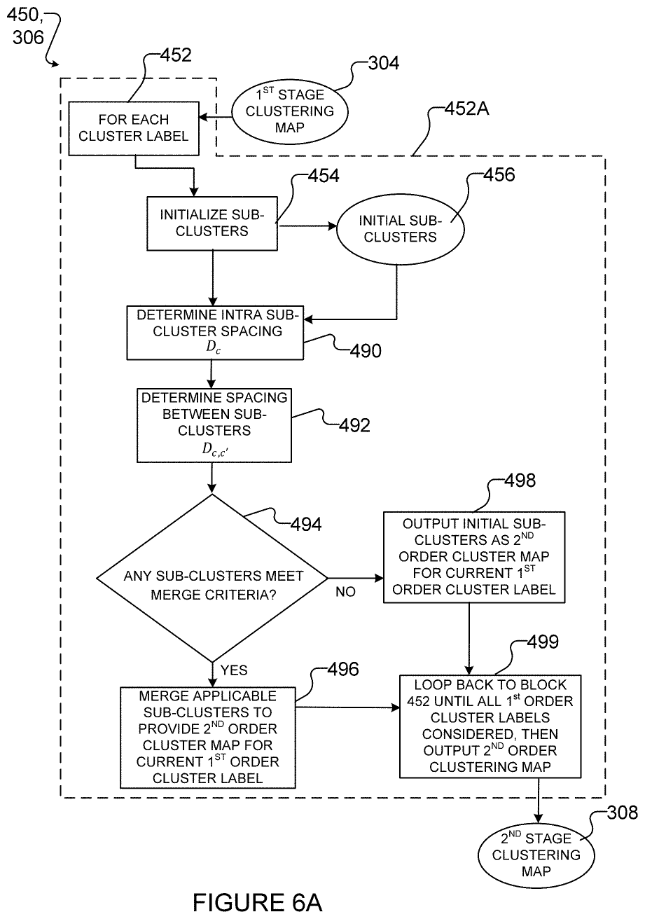

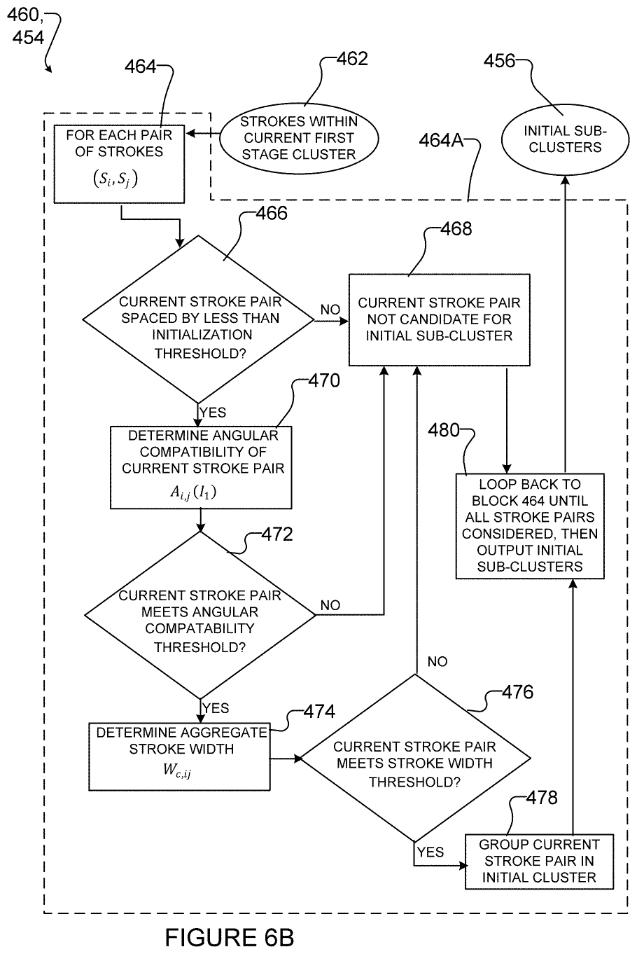

FIG. 6A schematically illustrates a method 450 for implementing the block 306 proximity based clustering refinement and using first stage clustering map 304 to obtain second stage clustering map 308 according to a particular embodiment. Method 450 may be performed by computer system 250 (FIG. 4), which is not expressly illustrated in FIG. 6A. For the purposes of explaining method 450, it is again assumed (without loss of generality) that raw drawing 204 is represented as (or can be converted to) a set of N strokes Sᵢ where i∈{1, 2, 3 . . . N} and that first stage clustering map 304 assign a cluster label to each of strokes Sᵢ where i∈{1, 2, 3 . . . N}. As described in more detail below, method 450 performs an average proximity analysis within the clusters of first stage clustering map 304 to ascertain whether any of the clusters in first stage clustering map 304 ought to be further divided to second stage clustering map 308 (FIG. 4).

Method 450 comprises a loop 452A which (in the schematic illustration of FIG. 6A) is controlled by block 452 and which is performed once for each cluster within first stage clustering map 304. In each iteration of loop 452A, the cluster within first stage clustering map 304 that is being considered may be referred to as the current first stage cluster. Control of loop 452A is represented (in the schematic illustration of FIG. 6A) by the “for” statement of block 452. Other than for explaining that loop 452A is performed once for each cluster within first stage clustering map 304, the details of the control of this loop 452A are not expressly described herein or shown in FIG. 6A.

In block 454, method 450 performs an initialization procedure for the current first stage cluster. The block 454 initialization analyzes the current first stage cluster and outputs a number of initialization sub-clusters 456 within the current first stage cluster. FIG. 6B schematically illustrates a method 460 for implementing the block 454 initialization according to a particular embodiment. Method 460 may be performed by computer system 250 (FIG. 4), which is not expressly illustrated in FIG. 6B. Method 460 comprises a loop 464A which (in the schematic illustration of FIG. 6B) is controlled by block 464 and which is performed once for each pair of strokes (Sᵢ,Sⱼ) in the current first stage cluster 462. In each iteration of loop 464A, the pair of strokes (Sᵢ,Sⱼ) in the current first stage cluster 462 that is being considered may be referred to as the current stroke pair (Sᵢ,Sⱼ). Control of loop 464A is represented (in the schematic illustration of FIG. 6B) by the “for” statement of block 464. Other than for explaining that loop 464A is performed once for each pair of strokes (Sᵢ,Sⱼ) in the current first stage cluster 462, the details of the control of this loop 464A are not expressly described herein or shown in FIG. 6B.

Method 480 (block 454) bases initialization sub-clusters 456 on the connectedness principle discussed above, which suggests that humans often perceive intersecting or near-intersecting strokes as being grouped together. To consider whether the current stroke pair (Sᵢ,Sⱼ) is intersecting or connected, block 466 involves a consideration of the distance between the strokes Sᵢ, Sⱼ in the current stroke pair (Sᵢ,Sⱼ). As discussed above, we may define an aggregate curve Sᵢⱼ^{A} which is fitted between the strokes Sᵢ, Sⱼ in the current stroke pair (Sᵢ,Sⱼ). The details of this aggregate curve fitting are discussed in more detail below. The aggregate curve Sᵢⱼ^{A} between the current stroke pair (Sᵢ,Sⱼ) provides the common parameterization between this stroke pair (Sᵢ,Sⱼ). For a point p e S on the stroke Sᵢ and a point q∈Sⱼ on the stroke Sⱼ, we may define the corresponding point p′∈Sᵢⱼ^{A} as its closest point on the aggregate curve Sᵢⱼ^{A} and a correspondence mapping q=Mᵢⱼ(p) may be defined where Mᵢ(p)=p′=Mⱼ(q) are the mappings from the strokes Sᵢ, Sⱼ to the aggregate curve Sᵢⱼ^{A}.

It will be appreciated that by this construction, the points p′, q, p are colinear and the line connecting them is orthogonal to the aggregate curve Sᵢⱼ^{A}. This construction is illustrated schematically in FIG. 6C, which shows strokes Sᵢ, Sⱼ in the current stroke pair (Sᵢ,Sⱼ), the aggregate curve Sᵢⱼ^{A} between the current stroke pair (Sᵢ,Sⱼ), a representative set of points p′, q, p and the lines (shown as dashed lines) on which the various points p′, q, p are located.

The average distance between the current stroke pair (Sᵢ,Sⱼ) may then be defined as:

$${D}_{i , j} ( {I}_{1} ) = \frac{1}{\vert {I}_{1} \vert} {\sum }_{{p}^{′} ∈ {I}_{1}} ‖ p - q ‖ \qquad ( 5 )$$

where I₁ is a section of interest (e.g. where points on the aggregate curve Sᵢⱼ^{A} have corresponding points on both of the current pair of strokes (Sᵢ,Sⱼ) and has the meaning described above and in FIG. 5B and where |Iⱼ| represents the number of samples along the section I₁. If the side by side section I₁ is empty, then the inter-stroke distance D_{i,j} may be set to a very large number (e.g. an approximation of +∞).

It may be observed at this stage, that the equation (5) formulation of the average distance between stroke pairs (Sᵢ,Sⱼ) directly employs the mapping between the stroke points, since at this point in the computation, the side-by-side portions (e.g. sections of interest I₁) of the strokes Sᵢ, Sⱼ being considered are roughly parallel, ensuring reliable correspondences. This was not the case for the angle difference computation (equation (1)), where, to obtain reliable values, strokes Sₜ, Sⱼ were mapped to the aggregate curve Sᵢⱼ^{A} instead of to one another.

In block 466, the average distance D_{i,j} between the current stroke pair (Sᵢ,Sⱼ) is compared to an initialization threshold to determine if the current stroke pair (Sᵢ,Sⱼ) is sufficiently close to be considered for a potential sub-cluster. The block 466 initialization threshold may be a configurable (e.g. user-configurable) parameter. In some embodiments, the block 466 initialization threshold is based on the stroke width Wₛ of one or both of strokes Sᵢ, Sⱼ in the current stroke pair. In one particular embodiment, the block 466 initialization threshold is based on a multiple of the larger one of the stroke widths Wₛ (e.g. 2Wₛ, 5Wₛ or the like) of strokes Sᵢ, Sⱼ in the current stroke pair. If the block 466 inquiry determines that the current stroke pair (Sᵢ,Sⱼ) is father apart than the initialization threshold (block 466 NO branch), then method 460 proceeds to block 468 and concludes that the current stroke pair (Sᵢ,Sⱼ) is not suitable for being an initial sub-cluster, before reaching block 480 and looping back to evaluate the next stroke pair. However, if the block 466 inquiry determines that the current stroke pair (Sᵢ,Sⱼ) is closer together than the initialization threshold (block 466 YES branch), then method 460 evaluates a number of other criteria before deciding that the current stroke pair (Sᵢ,Sⱼ) should form an initial sub-cluster.

Specifically, if the block 466 inquiry determines that the current stroke pair (Sᵢ,Sⱼ) is closer together than the initialization threshold (block 466 YES branch), then method 460 proceeds to block 470. Block 470 involves determining the angular compatibility of the current stroke pair (Sᵢ,Sⱼ). This angular compatibility A_{i,j}(I₁) may be determined in block 470 in accordance with:

$${A}_{i , j} ( {I}_{1} ) = {\sum }_{{p}^{′} ∈ {I}_{1}} arccos ( t ( p ) \cdot t ( q ) ) \qquad ( 6 )$$

where p′=Mᵢ(p)=Mⱼ(q) and t(p), t(q) are their respective unit tangents.

In block 472, the block 470 angular compatibility A_{i,j}(I₁) is compared to a suitable threshold. The block 472 angular compatibility threshold may be a configurable (e.g. user-configurable) parameter. In some embodiments, the block 472 angular compatibility threshold is based on the same angular compatibility parameter Tₐ discussed above in connection with block 414. In some embodiments, the block 472 angular compatibility threshold is the same angular compatibility parameter Tₐ (e.g. Tₐ=20°) discussed above in connection with block 414. If the block 472 inquiry determines that the angular compatibility A_{i,j}(I₁) of the current stroke pair (Sᵢ,Sⱼ) is greater than this angular compatibility threshold (block 472 NO branch), then method 460 proceeds to block 468 and concludes that the current stroke pair (Sᵢ,Sⱼ) is not suitable for being an initial sub-cluster, before reaching block 480 and looping back to evaluate the next stroke pair. However, if the block 472 inquiry determines that the angular compatibility A_{i,j}(I₁) of the current stroke pair (Sᵢ,Sⱼ) is less than this angular compatibility threshold (block 472 YES branch), then method 460 proceeds to block 474.

Block 474 involves determining a width parameter W_{c,i,j} of the joint aggregate curve of the current stroke pair (Sᵢ,Sⱼ). This width parameter W_{c,ij} may be determined by shooting left and right orthogonal rays from densely sampled points p∈I₁ on the section of interest I₁ on the aggregate curve Sᵢⱼ^{A} and locating the farthest left and right intersections iₗ(p) and iᵣ(p) with cluster strokes Sᵢ, Sⱼ along each ray. This width parameter W_{c,ij} may be determined (in some embodiments) according to:

$${W}_{c , ij} = max ( {W}_{s} , {median}_{p ∈ {I}_{1}} ( ‖ {i}_{l} ( p ) - {i}_{r} ( p ) ‖ ) ) \qquad ( 7 )$$

Method 460 then proceeds to block 476 which involves comparing a length to width ratio (narrowness) of an aggregate curve section I₁ (i.e. a ratio of the length of aggregate curve section I₁ to the block 474 width parameter W_{c,ij}) to a suitable width threshold Tₙ. The block 476 width threshold Tₙ may be a configurable (e.g. user-configurable) parameter. In some embodiments, the block 476 width threshold Tₙ is in a range of 5≤Tₙ≤10. In some embodiments, this width threshold Tₙ is set to be Tₙ=8.5. If the block 476 inquiry determines that the length to width ratio of an aggregate curve section I₁ is less than this width threshold Tₙ (block 476 NO branch), then method 460 proceeds to block 468 and concludes that the current stroke pair (Sᵢ,Sⱼ) is not suitable for being an initial sub-cluster, before reaching block 480 and looping back to evaluate the next stroke pair. However, if the block 476 inquiry determines that the length to width ratio of an aggregate curve section I₁ is greater than this width threshold Tₙ (block 476 YES branch), then method 460 proceeds to block 478 where the current stroke pair (Sᵢ,Sⱼ) is grouped together as an initial sub-cluster. After block 478, method 460 loops back to block 464 via block 480.

The method 460 loop 464A repeats for each pair of strokes to generate a number of initial sub-clusters 456 (see FIG. 6A). After loop 464A repeats for all of the stroke pairs in a given cluster of the first stage clustering map 304, then method 460 reaches block 480 for the last time and outputs these initial sub-clusters 456 (see FIG. 6A).

Returning to FIG. 6A, method 450 proceeds from block 454 to block 490, where an intra-sub-cluster spacing D_{c} is determined for each of the initial sub-clusters 456. This intra-sub-cluster spacing D_{c} is a parameter representative of a proximity of the strokes within each sub-cluster. To ascertain this proximity within a given sub-cluster C, the nearest neighbor stroke may be ascertained for each stroke in the sub-cluster C based on the inter-stroke distance D_{i,j}(equation (5)). Then, for each sub-cluster, the intra-sub-cluster spacing D_{c} may be determined to be the maximum of these distances:

$${D}_{c} = {max}_{i ∈ c} ( {min}_{j ∈ c , j ∉ i} ( {D}_{i , j} ) ) \qquad ( 8 )$$

Intuitively, the equation (8) intra-sub-cluster spacing parameter D_{c} returns the size of the largest gap between strokes in the each sub-cluster.

Method 450 then proceeds to block 492 which involves determining an inter-sub-cluster spacing parameter D_{c,c′} that is representative of a distance between two distinct sub-clusters C and C′. In some embodiments, the inter-sub-cluster spacing parameter D_{c,c′} between two distinct sub-clusters C, C′ may be ascertained by finding the closest distance between any two strokes, where each stroke belongs to a different sub-cluster:

$${D}_{c , {c}^{′}} = {min}_{i ∈ c , j ∈ {c}^{′}} {D}_{i , j} \qquad ( 9 )$$

Once the inter-sub-cluster spacing parameter D_{c,c′} is determined for each pair of sub-clusters C, C′ in the current set of initial sub-clusters, then method 450 proceeds to block 494 which involves an inquiry into whether any sub-clusters should be merged into a single sub-cluster. In one particular embodiment, the block 494 evaluation ascertains whether both of the following criteria are met for a sub-cluster pair C, C′ under consideration:

D_{c,c′}<T′_{d}·max(D_{c},D_{c′}) (10)

max(D_{c},D_{c′})<T′_{d}·min(D_{c},D_{c′}) (11)

Equation (10) evaluates whether the spacing between sub-cluster pairs C, C′ is less than a parameter T′_{d} times the maximum of the intra-sub-cluster spacings for each of the sub-cluster pair C, C′ under consideration. Equation (11) evaluates whether the maximum of the intra-sub-cluster spacings for each of the sub-cluster pair C, C′ under consideration is less than a parameter T′_{d} times the minimum of the intra-sub-cluster spacings for each of the sub-cluster pair C, C′ under consideration.

The parameter T′_{d} may be a configurable (e.g. user-configurable) parameter. In one particular embodiment, the parameter T′_{d} may be determined based on research into human proximity perception. The inventors conducted such a study which indicted that humans separate lines when the ratio of intra-cluster to inter-cluster distances reaches approximately T_{d}=2.1. The distances employed in method 450 are averaged along the sections of interest I₁, and are thus only approximating closest inter- and intra-sub-cluster distances. As discussed in more detail below, a more fine-grained analysis may be performed during subsequent local separation; therefore, to avoid over-segmentation at this stage, the block 494 evaluation may use T′_{d}=γ·T_{d} where γ is a configurable (e.g. user-configurable) parameter. In currently preferred embodiments, γ is set to be somewhere in a range of 1.1≤γ≤1.5.

If no sub-clusters meet the block 494 merge criteria, then method 450 proceeds to block 498. Block 498 involves outputting the initial sub-clusters 456 to be the second stage clustering map 308 for the current first stage cluster label. If any pairs (or larger groups) of of sub-clusters meet the block 494 merge criteria, then method 450 proceeds to block 496 which involves merging the applicable sub-clusters to provide the second stage clustering map 308 for the current first stage cluster label. Where there are sub-clusters that meet the block 494 merge criteria, the merging of sub-clusters between blocks 494 and 496 may be performed incrementally. That is, once a pair of sub-clusters is merged, the merged pair of sub-clusters becomes a candidate sub-cluster for further merge with other sub-clusters. In some embodiments, the merging computation of method 450 may be performed using the HDBSCAN algorithm described in Campello et al. Hierarchical Density Estimates for Data Clustering, Visualization, and Outlier Detection. ACM Trans. Knowl. Discov. Data 10, 1 (2015), 5:1-5:51, which is hereby incorporated herein by reference.

Whether by way of block 496 or 498, method 450 reaches block 499 when the analysis of the current first stage cluster label has been completed. Method 450 then loops back to block 452 to evaluate another first stage cluster label. When loop 452A has been performed for all of the first stage cluster labels, then method 450 outputs second stage clustering map 308 as the output of block 306 (see FIG. 4). It will be appreciated that second stage clustering map 308 may comprise the same number or more of clusters as first stage clustering map 304, since first stage clustering map 304 is further divided by the analysis of block 306 (method 450).

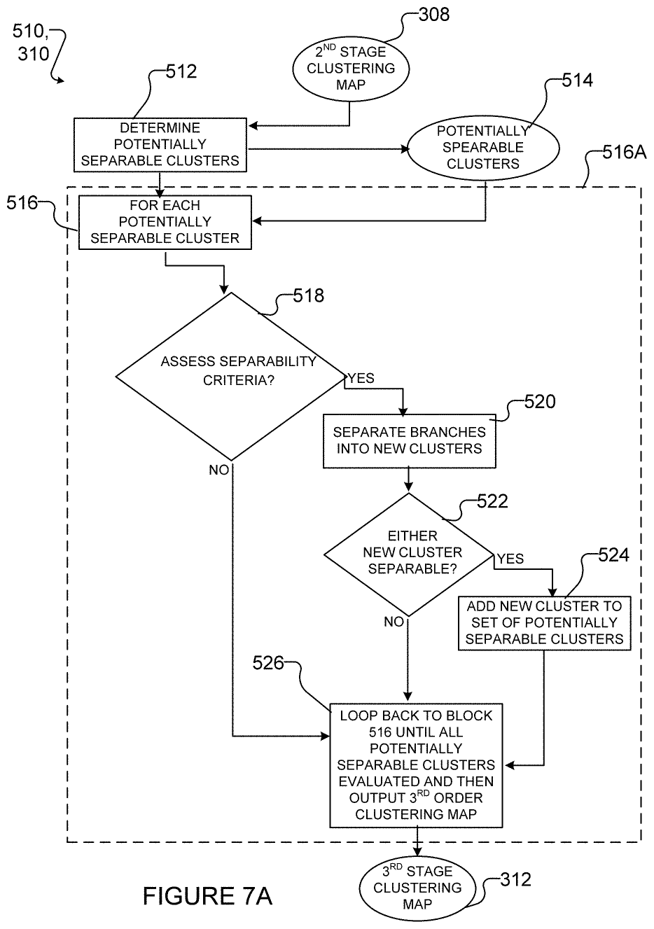

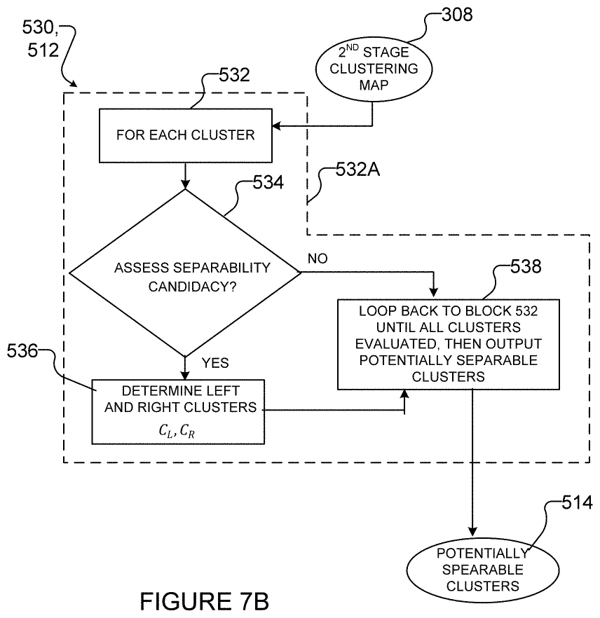

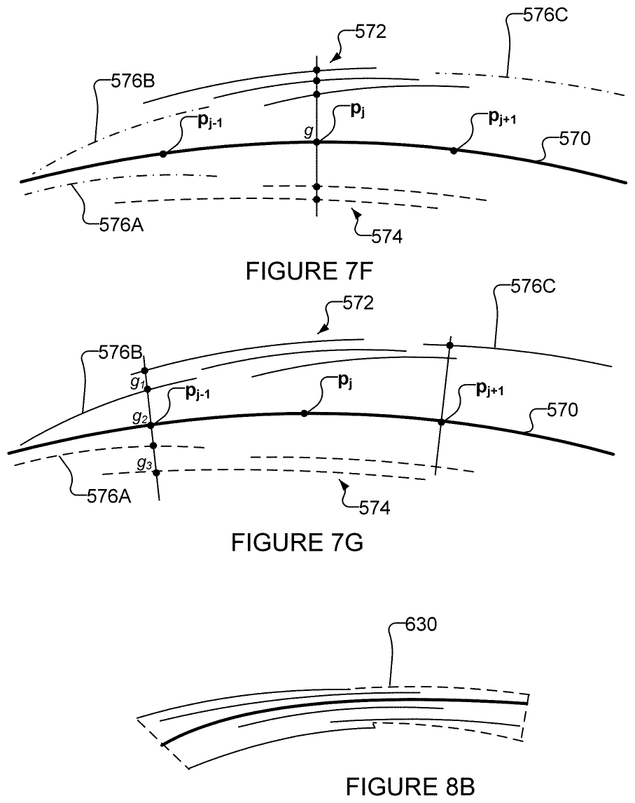

Returning to FIG. 4, method 300 then proceeds to block 310, which performs a cluster width and spacing uniformity analysis on second stage clustering map 308 to obtain a third stage clustering map 312. The clusters obtained thus far in method 300 (i.e. the second stage clustering map) 308 may be visually connected but may depict multiple connected curve branches instead of a single aggregate curve. This situation is depicted in FIG. 7C, where all of the strokes in cluster 556 appear visually connected, but strokes 550 (shown in dashed lines) are a different “branch” than strokes 552 (shown in solid lines), where curve 554 is an aggregate curve fitted to all of the strokes 550, 552. Block 310 may detect such multi-branch clusters and separate them into branches that correspond to individual aggregate curves using a recursive process. As explained in more detail below, for each candidate potentially separable cluster, one or both of two separability criteria may be assessed. One such separability criterion may be based on evenness of the internal spacing between cluster strokes and another may be based on cluster narrowness. Any candidate potentially separable cluster that satisfies either of these tests, may be split into a pair of new clusters (left and right branches). Each of these new clusters (left and right branches) may then be recursively subjected to the same block 310 process.

FIG. 7A schematically depicts a method 510 that may be used to perform the procedures of block 310 to consider second stage clustering map 308 and to assess whether these clusters may be further split to provide third stage clustering map 312 according to a particular embodiment. Method 510 may be performed by computer system 250 (FIG. 4), which is not expressly illustrated in FIG. 7A.

Method 510 starts in block 512, which involves assessing potentially separable clusters 514 from within second stage clustering map 308. FIG. 7B schematically depicts a method 530 that may be used to perform the procedures of block 512 to assess candidate potentially separable clusters from within second stage clustering map 308 and to return potentially separable clusters 514 according to a particular embodiment. Method 530 may be performed by computer system 250 (FIG. 4), which is not expressly illustrated in FIG. 7B.

Method 530 comprises a loop 532A which (in the schematic illustration of FIG. 7B) is controlled by block 532 and which is performed once for each cluster within second stage clustering map 308. In each iteration of loop 532A, the cluster within second stage clustering map 308 that is being considered may be referred to as the current second stage cluster. Control of loop 532A is represented (in the schematic illustration of FIG. 7B) by the “for” statement of block 532. Other than for explaining that loop 532A is performed once for each cluster within second stage clustering map 308, the details of the control of this loop 532A are not expressly described herein or shown in FIG. 7B.

Block 534 involves assessing separability candidacy criteria for the current second stage cluster by looking at the local spacing between strokes in the current second stage cluster. The block 534 separability candidacy assessment may be understood with reference to FIGS. 7C-E. In some embodiments, the block 534 assessment involves parameterizing the current second stage cluster 556 (FIG. 7C) by shooting orthogonal rays 554L, 554R (FIGS. 7D, 7E) from densely sampled points p on its aggregate curve 554 and determining the intersections of these rays 554L, 554R with the strokes of the current second stage cluster 556. These intersections may be ordered from leftmost to rightmost (with left and right defined with respect to the direction of aggregate curve 554. The lengths of these segments (which may be referred to herein as “gaps”) between consecutive intersections along individual rays 554L, 554R, may provide a local measurement of relative proximity. The set of gaps (segments between intersections) on the left of aggregate curve 554 (along ray 554L) may be referred to herein as the set G_{L}; set of gaps (segments between intersections) on the right of aggregate curve 554 (along ray 554R) may be referred to herein as the set G_{R}. The average length of the gaps in the set G_{L} may be referred to as g_{L} and the average length of the gaps in the set G_{R} may be referred to herein as g_{R}. As shown best in FIG. 7D, the gap between the rightmost intersection along the line 554L and the leftmost intersection along the line 554R may be referred to as the gap g under consideration. If the size of the gap g and the sizes of the gaps in the sets G_{L}, G_{R} (e.g. the average gap sizes g_{L}, g_{R}) are of roughly equal size, then visibly the intersection points and their corresponding strokes are likely to be grouped together. If, on the other hand, a gap g under consideration is much larger than the sizes of the gaps in the sets G_{L}, G_{R} (e.g. the average gap sizes g_{L}, g_{R}), then the intersections to the left and to the right and the strokes they lie on are potentially separable. This potentially separable situation is shown in FIG. 7D, which corresponds to the region 7D shown in FIG. 7C.

In one particular embodiment, the block 534 separability candidacy assessment comprises detecting candidate gaps g which indicate possible cluster separation using the ratio between the length of the gap g and the average lengths of the gaps to its left g_{L} and right g_{R} as a cue to its potential separability. Specifically, in some embodiments, a gap g may be considered to be a candidate for separation if:

$$g > \frac{{T}_{d} ( {g}_{L} + {g}_{R} )}{2} \qquad ( 12 )$$

If the gap g under consideration is the leftmost or rightmost gap, its size may only be compared against the average size of the gaps to the right (g_{R}), or left (g_{L}), respectively. If there is only one gap g (i.e. only two participating strokes), block 534 may involve setting g_{L}=g_{R}=2Wₛ, which is the same lower bound on gap size as in the block 454 (method 460, FIG. 6B) initialization. If a cluster within second stage clustering map 308 has any gaps g that satisfy these conditions, then the cluster may be considered to be a candidate for separation.

If the block 534 separability candidacy assessment is negative (i.e. the current cluster is not a candidate for separability), then method 530 proceeds to block 538 via the block 534 NO branch and loops back to block 532 to evaluate the next cluster. If, on the other hand, the block 534 separability candidacy assessment is positive (i.e. the current cluster is not a candidate for separability), then method 530 proceeds to block 536 via the block 534 YES branch. Block 536 involves splitting the potentially separable cluster into a pair of left and right sub-clusters C_{L}, C_{R}.

The schematic illustrations of FIGS. 7F and 7G are helpful for explaining the procedures of block 536 according to a particular embodiment. FIGS. 7F and 7G show an aggregate curve 570 (illustrated as a thick curve) and strokes in the cluster. The strokes shown in FIGS. 7F and 7G are shown in three categories: strokes assigned to the left sub-cluster C_{L} (shown in solid lines), strokes assigned to the right sub-cluster C_{R} (shown as dashed lines) and strokes yet to be assigned to one of the sub-clusters C_{L}, C_{R} (shown as alternating dash-dot lines).

In some embodiments, for a gap g at a point pⱼ on aggregate curve 570 corresponding to a cluster that is determined in block 534 to be potentially separable, block 536 may assign the strokes to the left and right of the gap g into the separate left and right sub-clusters, C_{L} and C_{R}, respectively. This is shown in FIG. 7F, where the strokes 572 to the left of gap g are assigned to sub-cluster C_{L} (and are therefore shown as solid lines) and the strokes 574 to the right of gap g are assigned to sub-cluster C_{R} (and are therefore shown as dashed lines). However, as shown in FIG. 7F, there are still three strokes 576A, 576B, 576C (collectively, strokes 576 shown as alternating dash-dot lines) which are not assigned to either sub-cluster C_{L}, C_{R} by this process. In some embodiments, block 536 may then involve assigning these remaining strokes 576 into one of sub-clusters C_{L}, C_{R} by advancing left and right through points along the aggregate curve 570 as long as all strokes 572, 574 currently or previously assigned to one of sub-clusters C_{L}, C_{R} do not intersect or switch sides with one another.

In some embodiments, at each encountered point on aggregate curve 570, the unassigned strokes may be split locally based on the largest gap between the previously assigned strokes 572, 574. Intuitively, the optimal assignment of the remaining strokes 576 is one that maximizes the average gap between the left and right sub-clusters C_{L}, C_{R}. In some embodiments, making such an assignment involves assessing a number of alternatives and selecting the assignment that produces the largest average gap ratio. Some embodiments involve testing three alternatives: assigning each stroke to the nearest, left or right, sub-cluster C_{L}, C_{R} based on shortest distance (e.g. between the unassigned stroke and the nearest stroke already assigned to a sub-cluster C_{L}, C_{R}); assigning all unassigned strokes to C_{L}, or assigning all unassigned strokes to C_{R}. An example of such an assignment is shown in FIG. 7G. At point pⱼ₋₁, there are three possible gaps between the left and right sub-clusters C_{L}, C_{R}: g₁ (which would result from assigning both strokes 576A, 576B to sub-cluster C_{R}), g₂ (which would result from assigning stroke 576A to sub-cluster C_{L} based on its shortest distance to C_{L} and assigning stroke 576B to sub-cluster C_{R} based on its shortest distance to C_{R} and g₃ (which would result from assigning both of strokes 576A, 576B to sub-cluster C_{L}). Of these gaps, g₂ is the largest. Consequently, stroke 576A is assigned to sub-cluster C_{L} and stroke 576B is assigned to sub-cluster C_{R}. At point, Pⱼ₊₁, there is only one possible assignment and stroke 576C is assigned to sub-cluster C_{L}, because if stroke 576C was assigned to sub-cluster C_{R}, then there would be an anomalous situation where there was a stroke assigned to sub-cluster C_{R} that is located between the strokes in sub-cluster C_{L}.

While it is not expressly shown in FIG. 7B, it will be appreciated that for a given second stage cluster within second stage clustering map 308, there may be a number of gaps g that satisfy the block 534 potential separability candidacy evaluation of equation (12). For each such gap g, there may be a corresponding assignment of potential left and right sub-clusters C_{L}, C_{R} (block 536). In some embodiments, the particular potential left and right sub-clusters C_{L}, C_{R} output from block 536 may be the left and right sub-clusters C_{L}, C_{R} with the highest R value (Rₘₐₓ). Determining the parameter R is discussed in more detail below. The particular set of left and right clusters C_{L}, C_{R} output from block 536 may be referred to herein as C*_{L}, C*_{R}.

Returning to FIG. 7B, once the left and right sub-clusters C_{L}, C_{R} are ascertained in block 536, then method 530 proceeds to block 538 and loops back to block 532 to evaluate the next cluster. When all of the clusters have been evaluated for potential separability, method 530 reaches block 538 for the last time and outputs a set of potentially separable clusters 514, each potentially separable cluster in set 514 having a pair of potential sub-clusters C*_{L}, C*_{R}.

Returning now to method 510 (FIG. 7A), method 510 proceeds to loop 516A. In the schematic illustration of FIG. 7A, loop 516A is controlled by block 516 and which is performed once for each potentially separable cluster in the set 514 of potentially separable clusters. In each iteration of loop 516A, the potentially separable cluster that is being considered may be referred to as the current cluster. Control of loop 516A is represented (in the schematic illustration of FIG. 7A) by the “for” statement of block 516. Other than for explaining that loop 516A is performed once for each potentially separable cluster in the set 514 of potentially separable clusters, the details of the control of this loop 516A are not expressly described herein or shown in FIG. 7A.

Block 518 involves assessing separability criteria for the current potentially separable cluster. In some embodiments, there are two separability criteria assessed in block 518: an evaluation of the evenness of the spacing between cluster strokes; and cluster narrowness. The evenness of the spacing between cluster strokes may be assessed as follows. Given a pair of sub-clusters C_{L}, C_{R} (i.e. a pair of sub-clusters C*_{L}, C*_{R} output from block 536 for a particular current potentially separable cluster, where we drop the asterisk notation for simplicity), block 518 may involve analyzing a parameter which is referred to herein as the gap ratio r. Determining the gap ratio r may involve iterating over the points p on the aggregate curve, where orthogonal left and right rays intersect both sub-clusters C_{L}, C_{R} and, for each ray, locating the leftmost intersection with the right sub-cluster C_{R} and the rightmost intersection with the left sub-cluster C_{L}. If these intersections are immediately next to one another, then block 518 may involve determining the ratio r between the size of the middle gap g and the average size of the average left and right gaps g_{L}, g_{R}, as above:

$$r = \frac{g}{( \frac{( {g}_{L} + {g}_{R} )}{2} )} \qquad ( 13 )$$

This circumstance is shown in FIG. 7D (which corresponds to rectangle 7D in FIG. 7C), where the aggregate curve 554 is shown in thick lines, the strokes in the sub-cluster C_{L} are shown in solid lines and the strokes in the sub-cluster C_{R} are shown in dashed lines. It can firstly be observed that the leftmost intersection with the right sub-cluster C_{R} and the rightmost intersection with the left sub-cluster C_{L} are adjacent to one another and define a gap g. In accordance with equation (13), a ratio r is determined between this gap and the average size of the average left and right gaps g_{L}, g_{R}. A gap ratio r greater than zero (r>0) may represent an indication that the current potentially separable cluster should be separated.

If the intersection order is flipped, the sub-clusters are locally connected. In this case, the gap ratio may be set to r=0. This circumstance is illustrated in FIG. 7E, where it can be seen that a stroke 555 from the sub-cluster C_{L} (shown in solid line) is intermingled with the strokes from the sub-cluster C_{R} (shown in dashed lines).

If the one of the sub-clusters C_{L}, C_{R} includes only a single stroke at a given point p on the aggregate curve, then the left and right gap values g_{L}, g_{R} may be ill-defined. Also, these gap values g_{L}, g_{R} can be arbitrarily small at a location where two or more strokes intersect; a division by a value close to zero would result in an arbitrarily large ratio value r. In some embodiments, both of these cases may be resolved by rounding

$$\frac{( {g}_{L} + {g}_{R} )}{2}$$

(the denominator of equation (13)) up to a lower bound. This lower bound may be determined by the average inter-stroke distances d_{L} and d_{R} within the left and right sub-clusters C_{L}, C_{R}. The inter-stroke distances may be determined in accordance with equation (5) discussed above. The denominator of equation (13) may be set to max

$$( \frac{{g}_{L} + {g}_{R}}{2} ,$$

min(max (d_{L}, d_{R}), 2Wₛ)).

These computed gap ratios r may be used in block 518 to determine if the left and right sub-clusters C_{L}, C_{R} are separable. In theory, if each of the left and right sub-clusters C_{L}, C_{R} had uniform internal spacing, the averages of the local ratios r could be compared to the proximity threshold T_{d} to determine if the two sub-clusters C_{L}, C_{R} should be separated (i.e. if r>T_{d}, then a potentially separable cluster could be separated and the block 518 inquiry would be positive). However, the current potentially separable cluster could have multiple branches. Thus, either of the left or right sub-clusters C_{L}, C_{R} may consist of more than one branch and, as a result, may have large internal gaps; this makes direct assessment of the gap ratio r less reliable.

To nevertheless separate such right and left sub-clusters, a more relaxed gap ratio assessment may be used by defining a parameter R to be the average of the largest 10% of the ratio values r and comparing R to the threshold T_{d} as a separation criterion (i.e. if R>T_{d}, then a potentially separable cluster may be separated and the block 518 inquiry may be positive). While this approach may occasionally lead to over-segmentation, the resulting split clusters may be merged back by subsequent analysis. As discussed above in connection with block 536, for a given cluster, there may be multiple potential left and right sub-clusters C_{L}, C_{R} and the techniques of one of both of methods 510 (e.g. block 518) and/or 530 (block 536) may choose the left and right sub-clusters C*_{L}, C*_{R} with the highest R value (Rₘₐₓ).

The block 518 inquiry may also involve examining if the current potentially separable cluster is sufficiently wide to merit separation. A cluster may be classified as wide or not based on its length l and its maximal gap gₘ (i.e. the largest gap in the union of G_{L}, G_{R}). In some embodiments, a cluster may be considered to be wide if the ratio of its length l to its maximal gap gₘ is less than some multiple of the narrowness threshold Tₙ. For example, in some embodiments, a stroke may be considered to be wide if

$$\frac{l}{{g}_{m}} < 2 {T}_{n} .$$

If it is determined, in the block 518 inquiry, that a potentially separable cluster should not be separated (block 518 NO branch), then method 510 proceeds to block 526 which involves looping back to block 516 and testing the next potentially separable cluster. If, on the other hand, it is determined, in the block 518 inquiry, that a potentially separable cluster should be separated (block 518 YES branch), then method 510 proceeds to block 520, where the sub-clusters C_{L}, C_{R} are separated into new clusters. Method 510 then proceeds to block 522 where each of the newly created clusters is assessed for potential separability. Other than for acting on the clusters newly created in block 520, the block 522 assessment may be similar to block 512 (method 530) discussed above. If neither of the newly created branches is potentially separable (block 522 NO branch), then method 510 proceeds to block 526 which involves looping back to block 516 and testing the next potentially separable cluster. If, on the other hand, it is determined, in the block 522 inquiry, then that newly created and potentially separable cluster is recursively added to the set of potentially separable clusters before looping back to block 516 (via block 526) and testing the next potentially separable cluster.

Loop 516A continues operating until all of the potentially separable clusters 514 (and all of the newly created clusters that themselves may be potentially separable) are evaluated and, if applicable, separated into new clusters. At the conclusion of loop 516A, method 510 outputs third stage clustering map 312.

In one particular embodiment, the procedures of block may be performed in accordance with a specific algorithm, which is reproduced below.

ALGORITHM 1: Recursive Branch Separation

```
Input: A set of strokes to separate, C.
Output: ResultBranches.
ResultBranches←{C};
PotentialSeparations←FindPotentialSeparations(C);
Rₘₐₓ←0; {C_{L}*, C_{R}*}←{C,0};
for each separation {C_{L}, C_{R}} in PotentialSeparations do
    R←ComputeGapRatio({C_{L}, C_{R}});
    if R>Rₘₐₓ then
          Rₘₐₓ←R; {C_{L}*, C_{R}*}←{C_{L}, C_{R}};
    end
end
if Rₘₐₓ> T_{d} or C violates Narrowness then
    LeftBranches←RecursiveBranchSeparation(C_{L}*);
    RightBranches←RecursiveBranchSeparation(C_{R}*);
    ResultBranches←LeftBranches ∪ RightBranches;
end
```

Returning to FIG. 4, method 300 then proceeds to block 314, which performs ambiguity resolving procedure on third stage clustering map 312 to obtain a final clustering map 212. Block 314 may involve re-assessing each pair of clusters in third stage clustering map and merging cluster pairs if the joint cluster satisfies a set of compatibility criteria (which may include criteria based on angle, proximity, and/or narrowness). This compatibility analysis may now (in block 314) be performed more reliably than in blocks 302, 306, as most clusters in third stage clustering map 312 contain multiple strokes, allowing for reliable relative proximity assessment and aggregate curve width estimation. As an optional step, block 314 may further consolidate the output drawing by detecting and enforcing T-junctions and shared end points between aggregate curves.

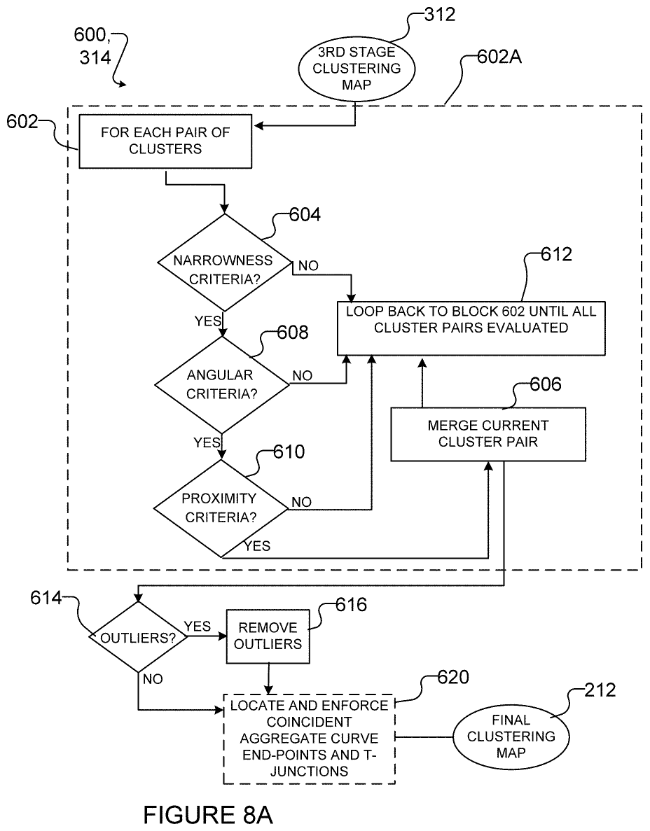

FIG. 8A schematically depicts a method 600 that may be used to perform the ambiguity resolution procedures of block 314 by processing third stage clustering map 312 and outputting a final stage clustering map 212 according to a particular embodiment. Method 600 may be performed by computer system 250 (FIG. 4), which is not expressly illustrated in FIG. 8A.

Method 600 comprises a loop 602A which (in the schematic illustration of FIG. 8A) is controlled by block 602 and which is performed once for each pair of clusters within third stage clustering map 312. In each iteration of loop 602A, the pair of clusters within third stage clustering map 312 that is being considered may be referred to as the current third stage cluster pair. Control of loop 602A is represented (in the schematic illustration of FIG. 8A) by the “for” statement of block 602. Other than for explaining that loop 602A is performed once for each cluster pair within third stage clustering map 312, the details of the control of this loop 602A are not expressly described herein or shown in FIG. 8A.

The current third stage clustering pair in loop 602A may be referred to herein using C_{L}, C_{R} to refer to the two clusters in the pair. In loop 602A, block 604 performs a narrowness assessment to evaluate whether the current third stage clustering pair C_{L}, C_{R} should be merged. The block 604 narrowness assessment may be similar to the narrowness assessment discussed above (e.g. in blocks 474, 476 of FIG. 6B) and may involve determining a common aggregate curve Sₗᵣ^{A} that corresponds to the union of the current cluster pair C_{L}, C_{R}. The block 604 narrowness assessment may be positive (block 604 YES branch) if the length to width ratio of the curve Sₗᵣ^{A} is greater than Tₙ, in which case method 600 proceeds to block 608. If the length to width ratio of the curve Sₗᵣ^{A} is less than Tₙ (block 604 NO branch), then the current cluster pair C_{L}, C_{R} is not merged and method 600 proceeds to block 612 (block 604 NO branch).

Block 608 involves assessing the angular compatibility within the section where the two clusters of the current cluster pair are side-by-side. Given the aggregate curve Sₗᵣ^{A} between the union of the current cluster pair C_{L}, C_{R} and the aggregate curves Sₗ, Sᵣ of the individual clusters in the current cluster pair C_{L}, C_{R}, block 608 may involve determining the average angle difference as described in above by equation (6) (see blocks 470, 472 of FIG. 6B) by averaging pointwise angle differences between Sₗ and Sᵣ with respect to Sₗᵣ^{A}. If the angle average A_{l,r} is less than the threshold Tₐ, then the clusters are angularly compatible (block 608 YES branch) and method 600 proceeds to block 610. If, on the other hand, the angle average A_{l,r} is greater than the threshold Tₐ, then the current cluster pair C_{L}, C_{R} is not merged and method 600 proceeds to block 612 (block 608 NO branch).

Block 610 involves an assessment of the proximity between the current cluster pair C_{L}, C_{R}. The block 610 assessment may attempt to overcome local noise by computing distances between clusters C_{L}, C_{R} that account for their average (rather than pointwise width).This average width may be used when computing distances between clusters C_{L}, C_{R} in regions where the pointwise width is smaller than the average. To this end, the notion of a cluster envelope may be introduced and determined based on the cluster's width. A cluster envelope may be designed to reflect an average width of the cluster and to contain all cluster strokes. To determine a cluster envelope, an aggregate curve S^{A} may be fit to each cluster in the current cluster pair C_{L}, C_{R} and the widths W_{c} of these curves may be determined in accordance with equation (7). Then, orthogonal rays may be projected left and right from densely ordered sample points on the cluster's aggregate curve S^{A}. For each point on the cluster's aggregate curve SA, if the distance from the curve S^{A} to the outermost intersection with a cluster stroke is larger than half the curve's width W_{c}, this intersection may be used as an envelope vertex; otherwise a point along the orthogonal ray at a half width

$$( \frac{{W}_{c}}{2} )$$

distance may be used as the envelope vertex. The vertices may then be connected on the left and right of the cluster's aggregate curve S^{A} to provide two envelope boundaries. The left and right vertices on the ends of the cluster may be connected to form a closed envelope. An example cluster envelope 630 is shown in FIG. 8B.

Block 610 may involve determining the median gap g within each cluster of the current cluster pair C_{L}, C_{R}. The median gap g for each cluster C_{L}, C_{R} may be determined by considering all gaps between adjacent intersections along all orthogonal rays emanating from sampled points on the aggregate curve and selecting the median gap. For median computation, rays that intersect only a single stroke and intersections which are less than a stroke width apart may be ignored.

In some embodiments, the block 610 proximity inquiry is positive if the local distance between the envelopes of the clusters in the current cluster pair C_{L}, C_{R} is less than

$$\frac{{T}_{d} ( {g}_{L} + {g}_{R} )}{2}$$

everywhere along their side-by-side sections (block 610 YES branch). Otherwise, method 600 proceeds to block 612 (block 610 NO branch). The local distances between the two envelopes along the rays may be computed in block 610 for each cluster pair and compared to the threshold. Noise may be accounted for in the block 610 assessment by ignoring sequences of gaps larger than this threshold if the length of this sequence (measured as distance between the originating samples of the rays) is less than min(5Wₛ, 0.1·L) where L is the length of the aggregate curve Sₗᵣ^{A} of the union of the current cluster pair C_{L}, C_{R}.

As mentioned above, relative proximity assessment of the type performed in block 610 encounters challenges for circumstances where there are fewer than three strokes being considered. This can be a challenge when attempting to assess the proximity of a single stroke cluster in block 610. Moreover, when drawing free-hand, artists do occasionally draw outlier strokes—strokes that are intended to depict a target aggregate curve but are sufficiently inaccurate to be visually separate from the other strokes in their intended cluster. Such ambiguous configurations may be handled by leveraging the strength in numbers principle. If the current cluster pair C_{L}, C_{R} has one cluster with multiple strokes and one cluster with only one stroke, a relaxed version of the proximity test may be applied in block 610. In such a relaxed proximity test, the block 610 inquiry may be negative if the shortest distance between the single stroke and the envelope of the multistroke cluster is greater than the median gap g (determined as discussed above) in connection with the multi-stroke cluster—block 610 NO branch—and method 600 proceeds to block 612. Otherwise, as before, the gaps between the multi-stroke cluster's envelope and the single stroke may be measured and compared to T_{d}·g. The strict proximity requirement discussed above may be relaxed the block 610 inquiry may be positive (block 610 YES output) if half the gaps within the side-by-side region between the multi-stroke cluster's envelope and the single stroke are below the threshold. If more than half of these gaps are above the threshold, the block 610 inquiry may be negative and method 600 may proceed to block 612 via the block 610 NO branch.

When both clusters of the current cluster pair C_{L}, C_{R} are single stroke clusters, block 610 may involve the same process as the multiple stroke-single stroke process described above, except that the stroke width Wₛ may be used instead of the gap size g.

If any one of the evaluations of blocks 604, 608 and 610 is negative, then the current cluster pair C_{L}, C_{R} is not merged and method 600 proceeds to block 612, where it loops back to block 602 to evaluate another cluster pair. If, on the other hand, all of the block 604, 608, 610 inquiries are positive, then method 600 proceeds to block 606 where the current cluster pair C_{L}, C_{R} is merged into a single cluster before looping back (via block 612) to block 602 to evaluate another cluster pair. In some embodiments, the newly formed cluster (formed by merging the current cluster pair in block 606) may be added to the 3^{rd} stage clustering map as a new cluster for consideration—i.e. method 600 is recursive in the sense that a newly formed cluster (formed by merging a cluster pair in block 606) may itself be merged with a third cluster.

Loop 602A concludes when all of the cluster pairs (optionally including any newly formed clusters) have been evaluated, in which case method 600 proceeds from block 612 to block 614 which involves an inquiry into whether there are outliers in the current set of clusters. Outliers represent a common artifact present in raw artist drawings. When artists draw clearly erroneous strokes, instead of deleting them, they frequently simply hide them underneath wide clusters of overdrawn strokes. To detect such outliers, for each pair of single-stroke and multi-stroke clusters, containment may be assessed as follows. The single stroke S may intersect with the cluster's envelope and the portion of the single stroke S which is outside the envelope may be measured. The stroke S may be classified as an outlier (block 614 YES branch) and removed from the clustering map (block 616) if the portion of the stroke S which is outside the envelope is less than some threshold percentage (e.g. 10% or 15% of its length).

In the illustrated embodiment of FIG. 8A, method 600 includes the optional procedure of block 620 which involves locating and enforcing coincident aggregate curve end-points and T-junctions. Block 620 may involve considering two endpoints of aggregate curves Sᵢ and Sⱼ with width Wᵢ and Wⱼ respectively as being coincident, if they are within a threshold distance of (e.g. Wᵢ+Wⱼ) from one another. Block 620 may consider an end-point of a curve Sᵢ as forming a T-junction with the curve Sⱼ if the end point of the curve Sᵢ is similarly within a threshold distance (e.g. Wᵢ+Wⱼ) from its closest point on Sⱼ. To enforce these detected connections, the stem end-points at T-junctions may be projected to the top curves of the T, and the shared end-points may be placed at their average locations. These detected connection constraints may be propagated along the curves by using standard Laplacian deformation (as described, for example, in Sorkine et al. 2004. Laplacian Surface Editing. In Proc. Symposium on Geometry Processing. 175-184, which is hereby incorporated herein by reference). The current positions and tangents of curve vertices may be used as references and the deformation may be triggered by constraining the curve end-points to their new locations.

As the conclusion of method 600, the output is a final clustering map 212.

### Fitting Artist-Intended Curves to Clusters of Strokes

Returning now to FIG. 4, final clustering map 212 is the output of block 314 and of the FIG. 4 method 300. Returning now to FIG. 2, clustering map 212 is the output of the block 210 coarse to fine clustering and is used as input to block 220 which involves fitting artist-intended curves to the block 210 clustering map 212. The objective of block 220 involves fitting an aggregate curve to a cluster of strokes. In particular embodiments, where strokes and curves are represented as polylines, the objective of block 220 may be to fit an aggregate polyline curve to a cluster of polyline strokes. It will be appreciated that this process (fitting an aggregate curve to a cluster of strokes) is used throughout the methods described herein. The process of block 220 may be used for fitting any of these aggregate curves described herein. In general, any suitable curve-fitting process may be used in block 220 and for the generation of any aggregate curves described herein. One particular embodiment of a suitable curve-fitting process is described here.

It will be appreciated that block 220 may be performed for each cluster in final clustering map 212. In determining the aggregate curve corresponding to a particular cluster, block 220 may seek to capture the curve's artist intended shape, and to explicitly preserve the slopes, or tangents, of the input strokes in the particular cluster. While the input points may be ordered along each given stroke, there is a challenge in block 220 in that there is, in general, no order between points on different strokes. Some curve fitting frameworks are not well designed for such data: traditional polyline or parametric curve fitting techniques for unordered data typically do not account for tangents, while implicit frameworks that use normals or tangents are typically designed for closed curves.

In some embodiments, block 220 involves the use of a modified Moving-Least-Squares (MLS) fitting algorithm (such as, for example, one of those described by Lee. 2000. Curve reconstruction from unorganized points. Computer aided geometric design 17, 2 (2000), 161-177 or Levin. 2004. Mesh-independent surface interpolation. In Geometric modeling for scientific visualization. 37-49, both of which are hereby incorporated herein by reference. The standard MLS formulation does not support tangent optimization, since tangent processing requires point order information which is not available in the MLS setting. To provide an ordering, the block 220 curve fitting may, in some embodiments, be split into three stages. First, an initial MLS optimization may be performed, where positions and tangents may be separately solved for; second, these positions and tangents may be used to compute an initial aggregate polyline; and third, the edges of this polyline may be aligned with the desired tangent directions.

To perform meaningful operations on point tangents in block 220, it is desirable for their orientations to be consistent. More specifically, it is desirable for point tangents along parallel or near-parallel strokes to have similar directions. This goal may be achieved as part of block 220 using a pair-based orientation method. The longest stroke in the cluster may be picked, and its orientation set as defined (for example, in the input or by some other orientation definition technique (e.g. user input)). The orientations of all other strokes may be set to be undefined. The closest pair of one defined stroke and one undefined stroke may then be repeatedly selected based on a distance computed as described below. An orientation may be assigned to the undefined stroke such that t(p)·t(p′)>0 using their respective representative points (p, p′). A distance value may be assigned to each pair of strokes as follows. If the midpoint tangents of the two strokes are near perpendicular (e.g. larger than 600 in some embodiments), their orientation with respect to one another may not be well defined. In such cases, the distance between the two strokes may be set to be arbitrarily large. This choice delegates the orientation decision to other more reliable pairs if these exist. If the midpoint tangents of the two strokes are not nearly perpendicular, close and representative pairs of points on the two strokes may be located. To avoid points with unreliable normals, some embodiments involve only considering points on each stroke whose tangents are within some threshold (e.g. within 60°) to the mid-point tangent. The closest pair of such sample points (p, p′) may then be selected and the distance between them may be used as the pairwise stroke distance. This process worked well for the data tested by the inventors and involves less computational expense than more complex alternatives such as eigenspace analysis described by Orbay et al. 2011. Beautification of design sketches using trainable stroke clustering and curve fitting. IEEE Trans. Vis. Comput. Graph 17, 5 (2011), 694-708, which is hereby incorporated herein by reference.

The initial block 220 fitting step uses Moving-Least-Squares (MLS) with adaptive neighborhood size [see Lee 2000; Levin 2004, supra]. The basic MLS framework may be adapted to simultaneously compute both position and tangent values. MLS takes a point cloud as the input and projects these points to the position-error-minimized manifold (the position stroke S^{P} in the case of the block 220 curve fitting process). To conduct the MLS projection step, each point may be associated with a local neighborhood. Following the method in Lee [2000], the neighborhood may be constructed by adaptively increasing the radius of a disk centered at each point. The radius may be increased until all points in this disk are adequately co-linear; that is, until the correlation reaches a minimum value ρ. Some embodiments may involve the use of an initial neighborhood size based on the stroke width Wₛ (e.g. h₀=10Wₛ and setting the minimum correlation to p=0.7). The point positions on SP may be obtained using the standard MLS projection.

The corresponding tangents may be determined as follows. Let p be the position of an input sample and t be its corresponding tangent. With the final neighborhood size h, the averaging kernel may now be defined for a position p⁰ with tangent t⁰ as:

$$K ( {p}^{0} , T ) = \frac{{\sum }_{p ∈ N ( {p}^{0} )} t \cdot θ ( ‖ p - {p}^{0} ‖ )}{‖ {\sum }_{p ∈ N ( {p}^{0} )} t \cdot θ ( ‖ p - {p}^{0} ‖ ) ‖} \qquad ( 14 )$$

The neighborhood N(p⁰) may be defined to include all the points p that satisfy ∥p−p⁰∥<αh and t·t⁰>β. Here, the neighborhood size h may be scaled by some suitable scaling factor α (e.g. α=0.6) to avoid tangent over-smoothing, since tangents are more sensitive than positions. The parameter β may be set to some suitable constant (e.g.

$$θ ( d ) = exp ( \frac{- {d}^{2}}{{( α h )}^{2}} )$$

to avoid averaging outlier tangents,

$$β = cos ( \frac{π}{3} )$$

is a Gaussian function, similar to the position Gaussian of the MLS projection.

After determining the positions and tangents for points on S^{P}, an ordered sequence of such points that will form the base for the output polyline may be extracted as part of block 220. This sequence may be determined as a path in a directed graph as follows. An Euclidean proximity graph may be constructed where each point is connected to all neighbors within the distance of h. Each edge in this graph may be assigned a direction that aligns with the averaged tangent of its two endpoints. When the dot product of the two tangents is negative, it suggests that one of them is an outlier and the edge is thus deleted. The minimum spanning may be extracted may then be determined, using, for example, Edmonds algorithm (as disclosed in Chu. 1965. On the shortest arborescence of a directed graph. Science Sinica 14 (1965), 1396-1400 and Edmonds. 1967. Optimum branchings. J. Res. Nat. Bur. Standards 71B, 4 (1967), 233-240 both of which are hereby incorporated herein by reference). The tree may be trimmed down to its largest path. It may be ascertained if the path is closed by searching for a path from its end to its beginning. If such a path exists, and its length is below a suitable threshold value (5Wₛ in one particular implementation), S^{P} may be labelled as closed. An artist may not precisely line up the start and end of a closed loop, and may accidentally extend the end of a closed loop past its starting point. To address this case in addition to the start to end path, paths between all vertices within 10% away from the start and end points may be tested.

Block 220 may then seek to optimize the polyline S={pᵢ}(i=1, . . . , n)) by aligning its edges (pᵢ, pᵢ+1) with the corresponding neighborhood tangents. In some embodiments, the objective function may be defined as:

$$d ( S , {S}^{A} ) = {\sum }_{i = 1}^{n} {‖ \frac{{p}_{i + 1} - {p}_{i}}{{p}_{i + 1} - {p}_{i}} - K ( {p}_{i} , T ) ‖}^{2} + λ {‖ {p}_{i} - {p}_{i}^{0} ‖}^{2} \qquad ( 15 )$$

where pᵢ⁰ is the initial position of point pᵢ on the aggregate polyline curve. Here, the first term enforces tangent alignment and the second term reflects the expectation that the polyline stays close to its original position. The parameter h may be set to some suitable value (e.g. λ=10⁻³) to prioritize tangent alignment.

Equation (15) may be minimized using any suitable fitting technique (e.g. iterated least squares and/or the like). The k^{th} round objective may be defined as

$$d ( {S}^{k} , {S}^{k - 1} ) \approx {\sum }_{i = 1}^{n} {‖ \frac{{p}_{i + 1}^{k} - {p}_{i}^{k}}{‖ {p}_{i + 1}^{k - 1} - {p}_{i}^{k - 1} ‖} - K ( {p}_{i}^{k - 1} , T ) ‖}^{2} + λ {‖ {p}_{i}^{k} - {p}_{i}^{0} ‖}^{2} \qquad ( 16 )$$

Here, the varying polyline edge length term in the denominator may be replaced with the known corresponding length in S^{k-1}; K(pᵢ^{k-1},T) is the average kernel centered at position pᵢ^{k-1} and T is the input tangent set. The aggregate tangent update helps center the curve and diminish the impact of outlier stoke tangents.

This least-squares problem may be solved using standard Cholesky decomposition. For smooth input data a single tangent update step is typically sufficient. However, solving the problem for multiple rounds may provide better results for highly noisy cases. The inventors have found three iterations to be sufficient for all experiments.

Once an aggregate curve is determined for each cluster in final clustering map 212, method 200 (FIG. 3) outputs a modified drawing 222 where the artist-intended aggregate curve replaces the strokes in each cluster. Examples of such modified drawings 222 are shown in FIGS. 1B (corresponding to the raw drawing of FIG. 1A) and 1D (corresponding to the raw drawing of FIG. 1C).

As discussed above, the block 220 method for determining an aggregate curve for a plurality of strokes may be used for determining any of the aggregate curves described herein.

### Interpretation of Terms

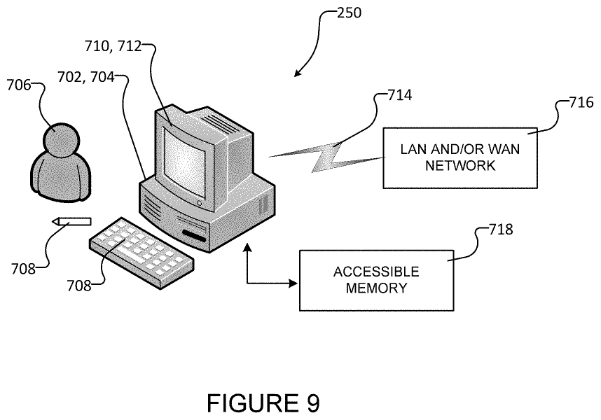

FIG. 9 is a schematic depiction of a particular embodiment of a computer system 250 which may be used to perform any of the methods described herein and the steps of any of the methods described herein according to a particular embodiment. Computer system 250 of the illustrated embodiment comprises one or more computers 702 which may comprise one or more processors 704 which may in turn execute suitable software (not expressly enumerated) accessible to processor(s) 704. When such software is executed by computer 702 (and in particular processor(s) 704), computer 702 and/or processor(s) 704 may perform any of the methods described herein and the steps of any of the methods described herein. In the illustrated embodiment, computer 702 provides a user interface 710 for interaction with a user 706. From a hardware perspective, user interface 710 comprises one or more input devices 708 (a stylus and a keyboard are shown in the illustrated embodiment) in by which user 706 can input information to computer 702 and one or more output devices 712 (a monitor is shown in the illustrated embodiment) by which information can be output to user 706. In general, input devices 708 and output devices 712 are not limited to those shown in the illustrated embodiment of FIG. 9. In general, input device 708 and output device 712 may comprise any suitable input and/or output devices suitable for interacting with computer 702—e.g. a stylus on a “touch-screen” tablet or “graphics” tablet. User interface 710 may also be provided in part by software when such software is executed by computer 702 and/or its processor(s) 704. In the illustrated embodiment, computer 702 is also connected to access data (and/or to store data) on accessible memory device 718. In the illustrated embodiment, computer 702 is also connected by communication interface 714 to a LAN and/or WAN network 716, to enable accessing data from networked devices (not shown) and/or communication of data to networked devices.

Input (e.g. raw drawings 204 (FIG. 2)) may be obtained by computer 702 via any of its input mechanisms, including, without limitation, by any input device 708, from accessible memory 718, from network 716 or by any other suitable input mechanism. The outputs (e.g. drawing with consolidated artist-intended curves 222) may be output from computer 702 via any of its output mechanisms, including, without limitation, by any output device 712, to accessible memory 718, to network 716 or to any other suitable output mechanism. As discussed above, FIG. 9 is merely a schematic depiction of a particular embodiment of a computer-based system 250 suitable for implementing the methods described herein.

Suitable systems are not limited to the particular type shown in the schematic depiction of FIG. 9 and suitable components (e.g. input and output devices) are not limited to those shown in the schematic depiction of FIG. 9.

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Where a record, field, entry, and/or other element of a database is referred to above, unless otherwise indicated, such reference should be interpreted as including a plurality of records, fields, entries, and/or other elements, as appropriate. Such reference should also be interpreted as including a portion of one or more records, fields, entries, and/or other elements, as appropriate. For example, a plurality of “physical” records in a database (i.e. records encoded in the database's structure) may be regarded as one “logical” record for the purpose of the description above and the claims below, even if the plurality of physical records includes information which is excluded from the logical record.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for converting a raw drawing comprising a plurality of strokes into an artist-intended curve drawing, the method comprising:
obtaining, at a computer system, a computer representation of a raw drawing, the raw drawing comprising a plurality of strokes, each stroke represented in a vector format in the computer system;
clustering, by the computer system, the plurality of strokes into one or more clusters, each cluster comprising a corresponding group of one or more strokes;
for each of the one or more clusters, performing a curve fitting, by the computer system, to thereby determine a computer representation of a corresponding aggregate curve that is fitted to the group of strokes in the cluster; and
generating, by the computer system, a computer representation of an artist-intended curve drawing corresponding to the raw drawing, the artist-intended curve drawing comprising the aggregate curve corresponding to each cluster in place of the group of one or more strokes corresponding to each cluster;
wherein clustering, by the computer system, the plurality of strokes into one more clusters comprises performing, by the computer system, a plurality of iterative procedures to either group strokes into precursor clusters or to divide precursor clusters into precursor sub-clusters based on one or more models of human perception of raw drawings comprising pluralities of strokes.

2. A method according to claim 1 wherein the plurality of iterative procedures to either group strokes into precursor clusters or to divide precursor clusters into precursor sub-clusters comprises:
generating, by the computer system, a precursor aggregate curve corresponding to a precursor cluster by performing, by the computer system, a curve fitting to fit the precursor aggregate curve to one or more strokes within the precursor cluster;
for each of a plurality of discrete points on the precursor aggregate curve, determining, by the computer system, at least one parameter of the one or more models; and
evaluating, by the computer system, whether the precursor cluster should be divided into precursor sub-clusters or combined with other strokes based on the at least one parameter determined at at least some of the plurality of discrete points on the precursor aggregate curve.

3. A method according to claim 2 wherein for each of the plurality of discrete points on the precursor aggregate curve, determining, by the computer system, the at least one parameter comprises:
determining, by the computer system, a first tangent t′ to the precursor aggregate curve at the point p′ on the precursor aggregate curve;
determining, by the computer system, a second tangent t to a stroke in the precursor cluster at a point p on the stroke closest to the point p′ on the precursor aggregate curve; and
determining, by the computer system, an angular distance between the first and second tangents (t, t′).

4. A method according to claim 3 wherein evaluating, by the computer system, whether the precursor cluster should be divided into precursor sub-clusters or combined with other strokes based on the at least one parameter determined at at least some of the plurality of discrete points on the precursor aggregate curve comprises determining, by the computer system, an aggregate angular distance between the stroke in the precursor cluster and the precursor aggregate curve based at least in part on a sum of the angular distances between the first and second tangents determined at the at least some of the plurality of discrete points on the precursor aggregate curve.

5. A method according to claim 4 wherein evaluating, by the computer system, whether the precursor cluster should be divided into precursor sub-clusters or combined with other strokes based on the at least one parameter determined at at least some of the plurality of discrete points on the precursor aggregate curve comprises determining, by the computer system, an aggregate angular distance between the stroke in the precursor cluster and a second stroke in the precursor cluster based on: the aggregate angular distance between the stroke in the precursor cluster and the precursor aggregate curve; and an aggregate angular distance between the second stroke in the precursor cluster and the precursor aggregate curve.

6. A method according to claim 5 wherein the plurality of iterative procedures to either group strokes into precursor clusters or to divide precursor clusters into precursor sub-clusters comprises:
determining, by the computer system, for each of a plurality of pairs of strokes (Sᵢ,Sⱼ) within the plurality of strokes of the raw drawing, an aggregate angular distance between the pair of strokes (Sᵢ,Sⱼ);
assigning, by the computer system, an angular compatibility score ComA(Sᵢ,Sⱼ) to each of the plurality of pairs of strokes (Sᵢ,Sⱼ) based on the aggregate angular distance between the pair of strokes (Sᵢ,Sⱼ); and
performing, by the computer system, an optimization which maximizes ΣᵢⱼComA(Sᵢ,Sⱼ)Yᵢⱼ, where Yᵢⱼ=1 if the pair of strokes (Sᵢ,Sⱼ) is grouped into a precursor cluster and Yᵢⱼ=0 otherwise.

7. A method according to claim 2 wherein the plurality of iterative procedures to either group strokes into precursor clusters or to divide precursor clusters into precursor sub-clusters comprises:
determining, by the computer system, for each of a plurality of pairs of strokes (Sᵢ,Sⱼ) within the plurality of strokes of the raw drawing, an aggregate angular distance between the pair of strokes (Sᵢ,Sⱼ);
assigning, by the computer system, an angular compatibility score ComA(Sᵢ,Sⱼ) to each of the plurality of pairs of strokes (Sᵢ,Sⱼ) based on the aggregate angular distance between the pair of strokes (Sᵢ,Sⱼ); and
performing, by the computer system, an optimization, which maximizes ΣᵢⱼComA(Sᵢ,Sⱼ)Yᵢⱼ, where Yᵢⱼ=1 if the pair of strokes (Sᵢ,Sⱼ) is grouped into a precursor cluster and Yᵢⱼ=0 otherwise, to groups strokes into precursor clusters.

8. A method according to claim 2 wherein, for each of the plurality of discrete points on the precursor aggregate curve, determining, by the computer system, the at least one parameter comprises:
projecting, by the computer system, a first ray to from the point p′ on the precursor aggregate curve and extending to a left of the precursor aggregate curve in a first orientation orthogonal to the precursor aggregate curve at the point p′;
projecting, by the computer system, a second ray from the point p′ on the precursor aggregate curve and extending to a right of the precursor aggregate curve in an second orientation orthogonal to the precursor aggregate curve at the point p′;
determining, by the computer system, the at least one parameter based on a first intersection of the first ray with a first stroke Sᵢ from among the plurality of strokes of the raw drawing and a second intersection of the second ray with a second stroke Sⱼ from among the plurality of strokes of the raw drawing.

9. A method according to claim 8 wherein, for each of the plurality of discrete points on the precursor aggregate curve, determining, by the computer system, the at least one parameter comprises determining an inter-stroke distance between a point p at the first intersection of the first ray with the first stroke Sᵢ and a point q at the second intersection of the second ray with the second stroke Sⱼ according to ∥p−q∥.

10. A method according to claim 9 wherein evaluating, by the computer system, whether a precursor cluster should be divided into precursor sub-clusters or combined with other strokes based on the at least one parameter determined at at least some of the plurality of discrete points on the precursor aggregate curve comprises determining a stroke separation parameter D_{i,j}(I₁) between the first stroke Sᵢ and the second stroke Sⱼ based, at least in part, on a sum, over the discrete points on the precursor aggregate curve in a section I₁ of the precursor aggregate curve where the first stroke Sᵢ and the second stroke Sⱼ are side-by-side, of the inter-stroke distances ∥p−q∥ between the point p at the first intersection and the point q at the second intersection.

11. A method according to claim 10 wherein evaluating, by the computer system, whether the precursor cluster should be divided into precursor sub-clusters or combined with other strokes based on the at least one parameter determined at at least some of the plurality of discrete points on the precursor aggregate curve comprises:
for each precursor cluster C, determining, by the computer system, an internal precursor cluster proximity parameter D_{c} based on the stroke separation parameters of the nearest neighbor strokes within the precursor cluster;
for each pair of precursor clusters C, C′ determining, by the computer system, an intercluster spacing D_{c,c′} parameter based on the smallest stroke separation parameter between any two strokes where one of the two strokes belongs to the first precursor cluster C and the second one of the two strokes belongs to the second precursor cluster C′; and
determining, by the computer system, that the pair of precursor clusters C, C′ should be merged into a single cluster based on evaluation of one or more merge criteria, the merge criteria based on the internal precursor cluster proximity parameters D_{c}, D_{c′} for each of the precursor clusters C, C′ and the intercluster spacing parameter D_{c,c′}.

12. A method according to claim 11 wherein determining, by the computer system, that the pair of precursor clusters C, C′ should be merged into a single cluster based on evaluation of one or more merge criteria comprises:
merging, by the computer system, the pair of precursor clusters C, C′ if both of:
D_{c,c′}<T′_{d}·max(D_{c},D_{c′})
max(D_{c},D_{c′})<T′_{d}·min(D_{c},D_{c′})
are true, where T′_{d} is a constant; and
maintaining the pair of precursor clusters C, C′ separate otherwise.

13. A method according to claim 2 wherein evaluating, by the computer system, whether a precursor cluster should be divided into precursor sub-clusters or combined with other strokes based on the at least one parameter determined at at least some of the plurality of discrete points on the precursor aggregate curve comprises:
for each precursor cluster C, determining, by the computer system, an internal precursor cluster proximity parameter D_{c} based on the stroke separation parameters of the nearest neighbor strokes within the precursor cluster;
for each pair of precursor clusters C, C′ determining, by the computer system, an intercluster spacing parameter D_{c,c′} based on a smallest stroke separation parameter between any two strokes where one of the two strokes belongs to the first precursor cluster C and the second one of the two strokes belongs to the second precursor cluster C′; and
determining, by the computer system, that the pair of precursor clusters C, C′ should be merged into a single cluster based on evaluation of one or more merge criteria, the merge criteria based on the internal precursor cluster proximity parameters D_{c}, D_{c′} for each of the precursor clusters C, C′ and the intercluster spacing parameter D_{c,c′}.

14. A method according to claim 9 comprising:
determining, by the computer system, that the first stroke Sᵢ and the second stroke Sⱼ are candidates for merger into a precursor cluster if, for any of the plurality of discrete points p′ on the precursor aggregate curve, the inter-stroke distance between a point p at the first intersection of the first ray with the first stroke Sᵢ and a point q at the second intersection of the second ray with the second stroke Sⱼ is less than a width threshold, the width threshold based on a width Wₛ of at least one of the first and second strokes; and
otherwise, determining by the computer system, that the first stroke Sᵢ and the second stroke Sⱼ are not candidates for merger into the precursor cluster.

15. A method according to claim 14 comprising, for each first stroke Sᵢ and second stroke Sⱼ determined to be candidates for merger into the precursor cluster:
determining, by the computer system, that the first stroke Sᵢ and the second stroke Sⱼ remain candidates for merger into the precursor cluster based, at least in part, on a sum, over the plurality of discrete points p′ on the precursor aggregate curve, of the angular distances between the tangents t at the point p at the first intersection of the first ray with the first stroke Sᵢ and at the point q at the second intersection of the second ray with the second stroke Sⱼ being less than a angular compatibility threshold, where p′=Mᵢ(p)=Mⱼ(q) and Mᵢ and Mⱼ are the mappings from the first and second strokes Sᵢ, Sⱼ to the precursor aggregate curve; and
otherwise, determining by the computer system, that the first stroke Sᵢ and the second stroke Sⱼ are not candidates for merger into the precursor cluster.

16. A method according to claim 15 comprising, for each first stroke Sᵢ and second stroke Sⱼ determined to remain candidates for merger into the precursor cluster:
determining, by the computer system, that the first stroke Sᵢ and the second stroke Sⱼ should be merged into the precursor cluster based, at least in part, on determining, by the computer system, that a length to width ratio of the precursor aggregate curve in a section where the first stroke Sᵢ and the second stroke Sⱼ are side by side is greater than a narrowness threshold and, if it is determined that the first stroke Sᵢ and the second stroke Sⱼ should be merged into the precursor cluster, merging the first stroke Sᵢ and the second stroke Sⱼ into the precursor cluster; and
otherwise, determining by the computer system, that the first stroke Sᵢ and the second stroke Sⱼ are not candidates for merger into the precursor cluster.

17. A method according to claim 16 wherein determining, by the computer system, that a length to width ratio of the precursor aggregate curve in a section where the first stroke Sᵢ and the second stroke Sⱼ are side by side is greater than a narrowness threshold comprises traversing the discrete points p′ on the precursor aggregate curve and determining the farthest left and right intersections iₗ(p) and iᵣ(p) with first and second strokes Sᵢ, Sⱼ and determining width W_{c,ij} of the precursor aggregate curve according to W_{c,ij}=max(Wₛ,median_{p∈I}_{₁}(∥iₗ(p)−iᵣ(p)∥)), where I₁ is the set of discrete points on the precursor aggregate curve where the first stroke Sᵢ and the second stroke Sⱼ are side-by-side.

18. A method according to claim 1 wherein performing, by the computer system, the plurality of iterative procedures to either group strokes into precursor clusters or to divide precursor clusters into precursor sub-clusters comprises dividing precursor clusters into precursor sub-clusters and wherein dividing precursor clusters into precursor sub-clusters comprises evaluating whether a precursor cluster should be divided into precursor sub-clusters and wherein evaluating whether a precursor cluster should be divided into precursor sub-clusters comprises:
assessing, by the computer system, one or more separability criteria for the precursor cluster; and
if the one or more separability criteria are satisfied:
assigning, by the computer system, strokes from the precursor cluster to one of a pair of potential sub-clusters C_{L}, C_{R};
otherwise determining, by the computer system, that the precursor cluster is not separable.

19. A method according to claim 18 wherein assessing the one or more separability criteria for the precursor cluster comprises:
generating, by the computer system, a precursor aggregate curve corresponding to the precursor cluster by performing, by the computer system, a curve fitting to fit the precursor aggregate curve to the strokes from the precursor cluster;
for each of a plurality of discrete points on the precursor aggregate curve:
projecting, by the computer system, a first ray to from the point p′ on the precursor aggregate curve and extending to a left of the precursor aggregate curve in a first orientation orthogonal to the precursor aggregate curve at the point p′;
projecting, by the computer system, a second ray from the point p′ on the precursor aggregate curve and extending to a right of the precursor aggregate curve in an second orientation orthogonal to the precursor aggregate curve at the point p′;
determining, by the computer system, intersections between the first and second rays and the strokes in the precursor cluster and determining, for each pair of adjacent intersections, a gap corresponding to the distance between the adjacent intersections;
wherein the one or more separability criteria at each point p′ are based at least in part on one or more of the gaps on the first and second rays projecting from the point p′.

20. A method according to claim 19 wherein assigning, by the computer system, strokes from the precursor cluster to one of a pair of potential sub-clusters C_{L}, C_{R} comprises, for a point on the aggregate curve where the one or more separability criteria are satisfied:
assigning, by the computer system, strokes in the cluster intersected by the first ray to the potential sub-clusters C_{L} and assigning strokes in the cluster intersected by the second ray to the potential sub-clusters C_{R}; and
considering, by the computer system, adjacent points on the aggregate curve and, at such adjacent points, assigning previously unassigned strokes to one of the potential sub-clusters C_{L}, C_{R} by an assignment that maximizes an average gap between the potential sub-clusters C_{L}, C_{R}.

21. A method according to claim 20 wherein assessing, by the computer system, the one or more separability criteria for the precursor cluster comprises:
determining, by the computer system, that the pair of potential sub-clusters C_{L}, C_{R} is separable based at least in part on a gap ratio r determined for at least some of the points p′ on the precursor aggregate curve, the gap ratio r determined according to:
$$r = \frac{g}{( \frac{( {g}_{L} + {g}_{R} )}{2} )}$$
where g is a gap between a rightmost intersection with the first ray and the leftmost intersection with the second ray, g_{L} is an average of the gaps between the intersections between the strokes from the precursor cluster and the first ray and g_{R} is an average of the gaps between the intersections between the strokes from the precursor cluster and the second ray.

22. A method according to claim 21 wherein determining, by the computer system, that the pair of potential sub-clusters C_{L}, C_{R} is separable based at least in part on a gap ratio r determined for at least some of the points p′ on the precursor aggregate curve comprises:
determining an aggregate gap ratio R based on the gap ratios r for a subset of the points p′ on the precursor aggregate curve;
if the aggregate gap ratio R is greater than a gap-ratio threshold, then determining, by the computer system, that the pair of potential sub-clusters C_{L}, C_{R} is separable and separating the potential sub-clusters C_{L}, C_{R} into new precursor clusters;
otherwise determining, by the computer system, that the pair of potential sub-clusters C_{L}, C_{R} should remain in the same precursor cluster.

23. A method according to claim 20 wherein assessing, by the computer system, the one or more separability criteria for the precursor cluster comprises:
comparing a narrowness of the precursor cluster to a narrowness threshold, the narrowness comprising a ratio of a length of the precursor cluster to a maximal gap of the precursor cluster;
if the narrowness of the precursor cluster is less than the narrowness threshold, determining, by the computer system, that the pair of potential sub-clusters C_{L}, C_{R} is separable and separating the potential sub-clusters C_{L}, C_{R} into new precursor clusters;
otherwise determining, by the computer system, that the pair of potential sub-clusters C_{L}, C_{R} should remain in the same precursor cluster.

24. A method according to claim 1 wherein performing, by the computer system, the plurality of iterative procedures to either group strokes into precursor clusters or to divide precursor clusters into precursor sub-clusters comprises:
assessing one or more unification criteria for a pair of precursor clusters;
if the one or more unification criteria are satisfied grouping the pair of precursor clusters into a single precursor cluster; and
otherwise determining that the pair of precursor clusters should remain as separate precursor clusters.

25. A method according to claim 24 wherein assessing one or more unification criteria for the pair of precursor clusters comprises at least one of:
assessing, by the computer system, narrowness criteria between the pair of precursor clusters, the narrowness criteria based on a length to width ratio of a combined precursor aggregate curve fit to strokes within the pair of precursor clusters;
assessing, by the computer system, an angular compatibility criteria:
between a first precursor aggregate curve fit to strokes within a first one of the pair of precursor clusters and the combined precursor aggregate curve; and
between the combined precursor aggregate curve and a second precursor aggregate curve fit to strokes within a second one of the pair of precursor clusters; and
assessing, by the computer system, a proximity criteria which comprises: defining a first envelope comprising a region that includes all of the strokes in the first one of the pair of precursor clusters; defining a second envelope comprising a region that includes all of the strokes in the second one of the pair of precursor clusters; and determining a distance between the first and second envelopes.

26. A computer system comprising one or more processors, the processors configured to:
obtain a computer representation of a raw drawing, the raw drawing comprising a plurality of strokes, each stroke represented in a vector format in the computer system;
cluster the plurality of strokes into one or more clusters, each cluster comprising a corresponding group of one or more strokes;
for each of the one or more clusters, perform a curve fitting to thereby determine a computer representation of a corresponding aggregate curve that is fitted to the group of strokes in the cluster; and
generate a computer representation of an artist-intended curve drawing corresponding to the raw drawing, the artist-intended curve drawing comprising the aggregate curve corresponding to each cluster in place of the group of one or more strokes corresponding to each cluster;
wherein the one or more processors are configured to cluster the plurality of strokes into one more clusters by performing a plurality of iterative procedures to either group strokes into precursor clusters or to divide precursor clusters into precursor sub-clusters based on one or more models of human perception of raw drawings comprising pluralities of strokes.
